(19) United States
(12) Patent Application Publication
(10) Pub. No.: US 2009/0292546 A1
(43) Pub. Date: Nov. 26, 2009

(54) Human Resources Employment Method

(76) Inventor: Jeffrey A. Aleixo, Torrance, CA (US)

Correspondence Address: MARC E. HANKIN, ESQ., 11414 THURSTON CIRCLE, LOS ANGELES, CA, 90049, US

(21) Appl. No.: 12/124,001

(22) Filed: May 20, 2008

(51) Int. Cl. G06Q 10/00; G06F 17/00; G06F 15/16; G06F 17/30; G06F 7/06

(52) U.S. Cl. 705/1; 715/226; 709/203; 707/104.1; 707/9; 707/3; 715/709

(57) ABSTRACT

Various embodiments of this invention disclose a computer-aided human resources employment system and method that electronically captures and shares, in real-time, human resources and unemployment events and the completed forms that relate to those events. Other embodiments of this invention disclose a computer-aided system for managing human resources and unemployment forms and data captured in those forms. Another embodiment of the invention relates to a system and method for managing unemployment claims. This invention also relates to a human resources employment computer-based product that manages human resources and unemployment forms and database information.

### FIELD OF INVENTION

This invention generally relates to a system and method for managing human resources and unemployment events, forms, and database information. Moreover, it pertains specifically to a computer-aided system and method that captures, and automatically shares in real time, human resources and unemployment events and the completed forms that relate to those events. Another embodiment of the invention relates to a system and method for managing unemployment claims. This invention also relates to a human resources employment computer-based product that manages human resources and unemployment forms and database information.

### BACKGROUND

Human resources information systems are well known in the prior art. The human resources information system allows employers to manage employee level data, such as pay grade, wages, insurance deductions, address, benefits, and other employee related information. An employer normally populates the human resources information system manually at the time the employee is first hired. Thereafter, all changes to an employee's information in the human resources information system and other employer databases are made in a reactive manner. For example, if an employee is terminated the employer's human resources department completes the termination manually and then reactively communicates the termination to the other interested departments and parties, such as payroll, secondary management, or legal. The other interested departments then update their records in a reactive manner to the event, which may have occurred days or even weeks before. Where the employee record as changed, such as a result of a termination, the human resources manager will go into the human resources information system and make the necessary edits so that the terminated employee will receive an appropriate termination paycheck. The manual record of the termination is then filed away in the human resources department's employee records physical file drawer. That physical file drawer is easily accessed only by the human resources or other management personnel who are in the same physical location as that file drawer. Indeed, if a third party provider is handling an unemployment claim filed by a terminated employee, the third party provider cannot easily access the termination form, or other associated documents, that are filed in the human resource department's employee records physical file drawer.

A human resource department's employee records is primarily made up of completed forms, such as leaves of absence, performance evaluations, disciplinary actions, benefit changes, department transfers, and terminations. Although some of the information on these forms is sometimes entered manually into the human resource information system, much of the information, such as the specific circumstances that led to a termination or what a terminated employee wrote on his or her termination form, is not entered and is only available to those who have physical access to the human resource department's employee records. This reactive, physical file drawer human resource department's employee records system represents the current state of the prior art.

There are numerous problems with a reactive, physical file drawer human resource department employee records system. First, once the forms are filed, they are not available easily to the various parties who require access to the form either immediately after completion of the form, or at a later time. Second, physical forms are often filled out incorrectly by the employer representative. Whether a form was filled out incorrectly is often discovered only when it is too late, such as during labor litigation or an unemployment hearing. Finally, even if the paper form is copied and distributed via a paper notification process, it is difficult to ensure, after each and every human resources event, that the appropriate parties receive the form when necessary, and do not receive the form when it is unnecessary. For example, a third party provider processing unemployment claims only needs to receive the termination, performance, disciplinary, and other types of forms of those employees that actually file an unemployment claim. The major stumbling block in creating a human resources employment system that addresses all of these problems is the need to capture the employee's actual signature on the human resources employment related documents or unemployment forms. Because many of the human resources or unemployment forms must be signed by the employee in order to prove that the employee agreed with, or had knowledge of, a substantive change in his or her employment, it is important that a computer-aided human resources employment system also capture the employee's signature and all additional written comments at the time the form is completed. The current state of the prior art human resources information systems and records systems simply fails to address or overcome the problems listed above.

The challenge of connecting human resources activities directly to unemployment claims administration activities in a paperless manner has not been successful to date due the unique employee/employer dynamic that exists when attempting to terminate or discipline an employee. Often the employer representative physically involved in the event does not even have the knowledge to request the necessary information to complete a successful termination. Often, this knowledge is only possessed by the employer's professional human resources manager. What is needed is a system, process, and product that addresses this issue by providing a rules engine to guide any and all employer representatives as they complete a human resources event.

In order to make a disciplinary or termination event legally binding, an employee is frequently required to acknowledge by ink signature the employee's receipt of the paperwork generated by the employer representative during the disciplinary or termination event. Additionally, the employee must be allowed at that time to provide written comments that will become a part of the employee's permanent personnel file. To date, all computer based systems have failed to overcome these signature and written comment requirements. Due to the unique dynamic and often negative atmosphere during a disciplinary or termination action, the employee is customarily sitting across the desk from the employer representative in adversarial positions. Trying to use a technological solution that removes the paper form from the adversarial event, such as a click and accept or personal identification number (PIN) technology, does not work in this setting because the upset employee would have to be asked to get up out of the chair and come around to the employer representative's desk and log on to the employer's computer and read the forms on the screen and then agree to their content. The physical dynamic of such a practice is not congruent with the setting. Further, asking an employee who is being disciplined or terminated to set up a PIN or remember a PIN they may have never used before to acknowledge them reviewing the documents is not a workable solution. Clearly, a solution is needed whereby the employee's signature and written comments are captured in a manner in which the employee feels most comfortable.

Although there are many different systems available in the prior art to help employers manage their human resource information systems, human resources forms, unemployment forms, and databases, none of these prior art systems captures electronically, and automatically shares in real time, human resources and unemployment events and the completed forms related to those events. Additionally, none of the prior art systems allow third party providers, such as an unemployment claims processor, to access an executed and signed human resources form. It is important to share the details contained in the human resources form, such as a termination form, so that the third party provider can make an educated decision, in the limited time provided, as to whether to allow the unemployment claim or protest the unemployment claim according to the unemployment code of the appropriate state.

Thus, there is a need in the art for a computer-aided human resources employment system, method, and product that electronically captures and shares, in real-time, human resources and unemployment events and the completed forms that relate to those events.

### SUMMARY OF THE INVENTION

To minimize the limitations in the prior art, and to minimize other limitations that will become apparent upon reading and understanding the present specification, the present invention discloses a method and system for managing human resources and unemployment forms and database information. Moreover, it pertains specifically to a computer-aided system, method, and product that captures, and automatically shares in real time, human resources and unemployment events and the completed forms that relate to those events.

One embodiment of the present invention is a computer-aided method of capturing a human resources event comprising the steps of: creating an electronic form; printing out said electronic form, wherein a printed form is created; placing said printed form on an electronic mark capture clipboard, wherein said electronic mark capture clipboard is programmed to capture in real time any marks made to the printed form with an ink-magnet pen and simultaneously capture said one or more marks into said electronic form; sharing said printed form with an employee, allowing said employee and an one or more employer representatives to mark said printed form with said ink-magnet pen; locking said electronic form after said printed form is finished being marked; distributing said printed form to said employee; distributing said electronic form to said one or more employer representatives via a virtual notification system; storing said electronic form in an electronic file drawer; allowing said one or more employer representatives to access said electronic form stored in said electronic file drawer; and sharing said electronic form with said one or more employer representatives before sharing said printed form with said employee. The computer-aided method of capturing a human resources event, wherein said electronic file drawer is classified and searchable by an individual employee.

Another embodiment of the present invention is a computer-aided method of managing human resources and unemployment forms comprising the steps of: completing an electronic employment application; transferring a plurality of employee demographic data from said electronic employment application to a human resources employment system, wherein said human resources employment system is a software program comprised of a program utility, a programmed forms database, a generic forms database, an employee demographic database, a reports database, a virtual notification system, an unemployment database, and an electronic file drawer, and wherein said electronic file drawer is classified and searchable by an individual employee, and wherein said employee demographic database is classified and searchable by said individual employee. The computer-aided method further comprises: transferring a plurality of employee demographic data from said electronic employment application to a human resources information system; transferring a plurality of employee demographic data from said human resources information system to a payroll feed; and transferring a plurality of employee demographic data from said payroll feed to said employee demographic database, wherein said plurality of employee demographic data from said payroll feed overwrites said plurality of employee demographic data previously transferred from said electronic employment application. The computer-aided method further comprises, using said program utility to create a plurality of forms within said human resources employment system, wherein said plurality of forms have an one or more employee demographic fields, and wherein said plurality of forms have an one or more substantive data fields, and wherein said plurality of forms are stored in said generic forms database before they are personalized or programmed. The computer-aided method further comprises: personalizing said plurality of forms to conform to the needs of an employer; programming said plurality of forms, by a form type, to be distributed automatically to an one or more employer representatives via said virtual notification system after said plurality of forms are locked; programming said plurality of forms with a tutorial system that provides real time legal guidance to said one or more employer representatives as to how to appropriately complete said one or more substantive data fields of said plurality of forms; and programming said plurality of forms with a legal notification system that flags in real time an one or more inappropriate words in a comment that said one or more employer representatives enters into said plurality of forms, and suggests an one or more alternative words for said comment. The computer-aided method further comprises: storing said plurality of forms in said programmed forms database after said plurality of forms are personalized and programmed; accessing a specific form from said programmed forms database; pre-populating electronically an one or more demographic fields of said specific form with said plurality of employee demographic data available from said employee demographic database; and completing electronically said one or more substantive data fields in said specific form, wherein said tutorial system provides said real time legal guidance to said one or more employer representatives, wherein said legal notification system flags in real time said one or more inappropriate words in said comment that said one or more employer representatives enters into said plurality of forms, and wherein said legal notification system suggests said one or more alternative words for said comment. The computer-aided method further comprises: sharing electronically said specific form with additional said one or more employer representatives before said specific form is shared with an employee to whom said specific form relates; allowing additional said one or more employer representatives to edit said specific form before said specific form is shared with said employee to whom said specific form relates; printing said specific form, wherein said specific form is divided into a printed specific form and an electronic specific form; placing said printed specific form on an electronic mark capture clipboard, wherein said electronic mark capture clipboard is programmed to capture in real time an one or more marks made to said printed specific form with an ink-magnet pen and simultaneously capture said one or more marks into said electronic specific form; sharing said printed specific form with said employee; allowing said employee to mark said printed specific form with said ink-magnet pen; allowing said one or more employer representatives to mark said printed specific form with said ink-magnet pen; locking said electronic specific form after said printed specific form is finished being marked, wherein said electronic specific form is automatically date stamped at locking; distributing said printed specific form to said employee; distributing automatically said electronic specific form to said one or more employer representatives via said virtual notification system; storing said electronic specific form in said electronic file drawer; storing a plurality of substantive data from said substantive data fields in said reports database; allowing said one or more employer representatives to access said electronic file drawer to retrieve an one or more locked and stored electronic forms; allowing said one or more third parties to access said human resources employment system and said electronic file drawer to retrieve said one or more locked and stored electronic forms; allowing said one or more third parties to access said human resources employment system and said electronic file drawer to retrieve said employee demographic data; allowing said one or more third parties to place an one or more third party forms in said electronic file drawer; and allowing said one or more employer representatives to attach an one or more supplementary documents to said electronic specific form, wherein said one or more supplementary documents are stored with said electronic specific form in said electronic file drawer after said electronic specific form is locked. The computer-aided method of managing human resources and unemployment forms wherein said specific form is a request form. The computer-aided method further comprises: sending electronically said request form to said one or more third parties; receiving electronically a result form from said one or more third parties in response to said request form; and storing said result form in said electronic file drawer. The computer-aided method wherein said unemployment database is used to respond to and manage an unemployment claim.

One embodiment of the present invention is a human resources employment computer-based product comprising: a human resources employment system comprising a program utility, a programmed forms database, a generic forms database, an employee demographic database, a reports database, a virtual notification system, an unemployment database, and an electronic file drawer; an electronic mark capture clipboard; a payroll feed; a human resources information system; and an electronic employment application. The computer-based product wherein: a specific form is placed on said electronic mark capture clipboard and shared with an employee during a human resources event; said electronic mark capture clipboard captures electronically an one or more marks made on said specific form during said human resources event; said specific form and said one or more marks generated during said human resources event are automatically shared with an one or more employer representatives; said specific form is stored in said electronic file drawer after said human resources event; said plurality of forms are stored in said generic forms database; said program utility programs and personalizes said plurality of forms to create a plurality of programmed forms; said plurality of programmed forms are stored in said programmed forms database; said specific form is accessed from said programmed forms database; an one or more stored forms in said electronic file drawer are accessible by said one or more employer representatives and by an one or more third parties; said one or more third parties file an one or more third party forms in said electronic file drawer; said electronic file drawer is classified and searchable by an individual employee; said employee demographic database is classified and searchable by said individual employee; an one or more data fields from said specific form is stored in said reports database; said reports database is accessible by said one or more employer representatives; said payroll feed automatically populates said employee demographic database; said human resources information system automatically populates said payroll feed; an one or more employee demographic data fields in said electronic employment application automatically populate said employee demographic database; said unemployment database is used to respond to and manage an unemployment claim; and said payroll feed overwrites said employee demographic database.

Another embodiment of the invention is a computer-aided method for managing unemployment claims comprising the steps of: receiving an unemployment claim; accessing a human resources employment system that is available on-line; searching said human resources employment system by an one or more employee demographic data of an employee that filed said unemployment claim; retrieving an one or more electronic forms that relate to said employee that filed said unemployment claim; ensuring that correct state's laws are applied to the unemployment claim; creating an unemployment insurance claim record; responding to said unemployment claim in a timely manner; creating an unemployment insurance hearing record of said unemployment claim; and creating an unemployment insurance charge record of said unemployment claim. The computer-aided method wherein said human resources employment system comprises an unemployment database; and wherein said unemployment database is used to respond to and manage the unemployment claim. The computer-aided method wherein: a party receiving and responding to said unemployment claim is a third party provider; said human resources employment system comprises an electronic file drawer; said forms are stored in said electronic file drawer; and said unemployment insurance claim record, said unemployment insurance hearing record, and said unemployment insurance charge record are stored in said electronic file drawer.

It is an object of the present invention to provide a human resources employment system and method that possesses several novel features that improve how human resources and unemployment data and forms are managed and that overcomes the limitations of the prior art. These features include recording all human resources and unemployment events in an electronic format at the occurrence of the event, in real time.

It is an object of the present invention to provide a human resources employment product that possesses several novel features that improve how human resources and unemployment data and forms are managed and that overcomes the limitations of the prior art. These features include recording all human resources and unemployment events in an electronic format at the occurrence of the event, in real time.

It is an object of the invention to capture in real time the occurrence of human resources events electronically in a data file.

The data files are presented as electronic forms that are locked and unalterable after the occurrence of the human resources event is completed and executed. These forms can then be directed or portaled via a virtual notification system to any designee, or designated universe, automatically at the time of locking. The virtual notification system can also be programmed to send calendar reminders to update entire forms or specific information from the forms.

It is an object of the invention to capture in real time all additional comments, notes, and signatures of the parties involved in the human resources event before the electronic forms are locked.

The present invention also allows for the real time presentation of the forms for comment, acknowledgements, releases, and confirmations by signature before the form is locked.

The present invention provides tutorials that guide the employer representatives in appropriately filling out the forms.

The present invention flags inappropriate text entered into the forms and suggests possible replacement words.

The present invention flags inappropriate actions to be taken that are entered into the forms and suggests possible replacement actions to be taken.

It is an object of the present invention to flag the inappropriate actions and texts based on the laws of the State where the human resources event occurs or where the employee is employed.

It is another object of the present invention to store the executed forms in an electronic file drawer wherein the forms are retrievable by employee demographic information. The data entered into the forms is separately retrievable and can be pulled to create activity and event reports.

The present invention has tremendous advantages over current systems for managing human resources employee records. Currently, most employment related events occur in isolation from the numerous other parties that must be informed of that event in order to aid in the event, process the event, and prepare for actions to be taken after the event. Further, the paper forms are filled out and executed with the employee, but the forms themselves are not appropriately distributed after execution. Additionally, once the forms are stored physically, it is very difficult for third parties or off-site personnel to retrieve these forms. Finally, even if the forms are retrieved, because they were prepared in isolation, there is a significant possibility that they have been filled out incorrectly, and are now harmful to the employer. This reactive paper based system was thought to be necessary because of the unique and often adversarial nature of human resources and unemployment events. Because human resources events require an employee's signature, which up to the time of the present invention has been a strictly manual process in the human resources and unemployment fields, the downstream sharing of that event has also been a manual process. The present invention provides solutions to these problems by specifically addressing the challenging dynamic that is present between an employer and employee during the disciplinary and termination process. The tutorials and flags ensure that the form is filled out correctly. The forms are shared automatically upon execution with pre-programmed designees. The forms can be distributed for comments before they are shared with the employees. The executed forms are stored electronically and are easily retrievable by anybody that is granted access to the human resources employment system of the present invention. Finally, the present invention captures simultaneously, electronically and manually, the comments, notes, and signatures of the participants to the human resources event. This allows the employee to keep the ink and paper manual copy of the form and, at the same time, the employer shares and stores the alternate, and very much legitimate, electronic copy of the form.

The present invention provides the use of an electronic clipboard tethered to a long USP cord tied directly to a computer programmed with human resource forms whereby all of the information is presented to the employee on paper that is attached to the clipboard, whereby the employee can sign and provide comments on that paper while remaining seated across the desk from the employer representative. After the employee completes the necessary acknowledgement, signature, or written comments, s/he may then take the paper copy with them as his or her own copy. The advantage of this type of electronic capturing of employee acknowledgement and response is that this process and system is the most similar to how terminations and disciplinary actions have been performed in the past. Therefore, the event itself remains more calm and beneficial for all. The system, method, and product of the present invention captures and retains the activity without any additional stress on the employee. The present invention is an effective way to capture electronically employment related activities such as employer disciplinary and termination events.

The virtual notification system of the present invention resolves a long standing problem in communicating with the various internal departments such as Legal, Human Resources, and Payroll. Currently the timeliness, availability and content of human resources actions such as termination, leave of absence, disciplinary activities, or performance evaluations, which need to be communicated to the various departments impacted by such actions, is reliant upon a local manager and his or her ability to communicate these activities in a timely and complete manner. Unfortunately, the local managers rarely communicate this information in a timely or complete manner. The local manager is burdened with other day to day priorities before ever being able to log into a human resources system, if there even is one, or send updated information to the various internal departments via email. These updates on any and all employment related activities may need to be entered or communicated either at the end of that day, that week, or that month. Invariably, when the updates are finally sent to the various parties needing that information, those updates require additional work because they are exceptions to the process because usually they are delivered after the fact. The virtual notification system of the present invention solves this lag in time between the actual human resources event and when the various managing departments such as Legal, Human Resources, and Payroll are notified of the relevant information.

Other features and advantages are inherent in the system, method, and product claimed and disclosed will become apparent to those skilled in the art from the following detailed description and its accompanying drawings.

### BRIEF DESCRIPTION OF THE DRAWINGS

FIG. 1 illustrates in block diagram form, one embodiment of the present invention.

FIG. 2 illustrates in flow-chart diagram form, one embodiment of the present invention.

FIG. 3 illustrates in flow-chart diagram form, one embodiment of the present invention.

FIG. 4 illustrates in flow-chart diagram form, one embodiment of the present invention.

FIG. 5 is a screen shot from an on-line program that has accessed the electronic employment application page for one embodiment of the invention.

FIG. 6 is a screen shot from an on-line program that has accessed the electronic employment application choice of state page for one embodiment of the invention.

FIG. 7 is a screen shot from an on-line program that has accessed the forms creation page of the program utility for one embodiment of the invention.

FIG. 8 is a screen shot from an on-line program that has accessed the forms creation page of the program utility for one embodiment of the invention and shows the employer demographic information being collected.

FIG. 9 is a screen shot from an on-line program that has accessed the forms creation page of the program utility for one embodiment of the invention and shows the selection of forms in the generic forms database to be programmed and personalized.

FIG. 10 is a screen shot from an on-line program that has accessed the forms creation page of the program utility for one embodiment of the invention and shows a form being programmed and personalized.

FIG. 11 is a screen shot from an on-line program that has accessed the programmed forms database for one embodiment of the invention.

FIG. 12 is a screen shot from an on-line program that has accessed the programmed forms database for one embodiment of the invention.

FIG. 13 is a screen shot from an on-line program that has accessed a webpage for one embodiment of the invention that is a specific, programmed, and personalized termination form and shows a legal flag.

FIG. 14 is a screen shot from an on-line program that has accessed a webpage for one embodiment of the invention that is a specific, programmed, and personalized performance review form.

FIG. 15 is a screen shot from an on-line program that has accessed a webpage for one embodiment of the invention that is a specific, programmed, and personalized disciplinary action form.

FIG. 16 is a printed copy of a disciplinary action form of one embodiment of the invention.

FIG. 17 is a screen shot from an on-line program that has accessed a disciplinary action form page for one embodiment of the invention that was signed with an electronic mark capture clipboard.

FIG. 18 is a screen shot from an on-line program that has accessed the electronic file drawer page for one embodiment of the invention.

FIG. 19 is a screen shot from an on-line program that has accessed the electronic file drawer page for one embodiment of the invention.

FIG. 20 is a screen shot from an on-line program that has accessed the notification page for one embodiment of the invention.

### DETAILED DESCRIPTIONS OF THE DRAWINGS

In the following detailed description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance the term “mark” refers to any mark, either purposeful or inadvertent, notation, date, or signature made to a paper copy of a form. The term “electronic mark capture clipboard” refers to any device that is attachable to a computer, either physically or wirelessly, and captures simultaneously on that computer any mark made to a paper form resting on the electronic mark capture clipboard. The term “ink-magnet pen” refers to any marking tool that will simultaneously mark a paper form with ink and an electronic form with the same mark via the magnetic properties of the pen. Although the ink-magnet pen preferably uses ink, the ink-magnet pen may also function by using graphite or some other physically visible marking material. The ink-magnet pen may also use some other electronic mechanism, other than a magnet, that effectively translates and transmits a physical mark to an electronic copy of the form.

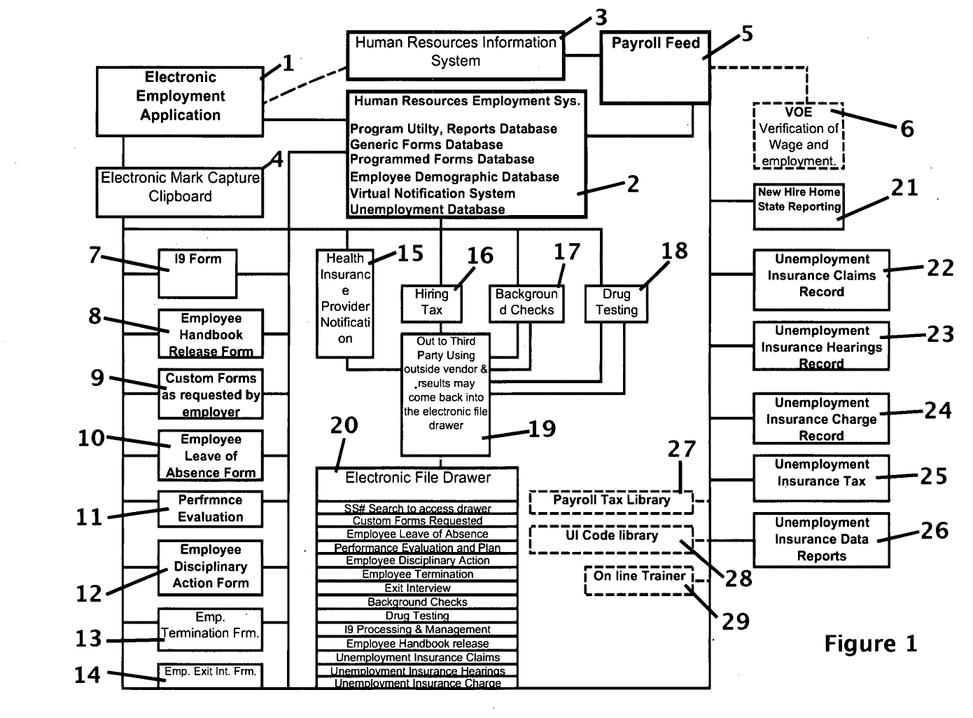

FIG. 1 illustrates in block diagram form, one embodiment of the present invention. As shown in FIG. 1, the present invention can be a system, method, or product, and consists of several connected computer based systems, methods and products. In the preferred embodiment of the present invention employee demographic information is first captured in an electronic employment application 1. The electronic employment application 1 is filled out at a standard computer terminal and the employee fills out numerous demographic and background data fields. However, the potential employee filling out the electronic employment application 1 can also use the electronic mark capture clipboard 4 to fill out or sign the electronic employment application. The electronic mark capture clipboard captures simultaneously all marks made to a paper copy of the application within an electronic copy of the application. Preferably, data from the electronic employment application 1 is transferred automatically to the human resources employment system 2. However, data from the electronic employment application 1 can be transferred manually as well. In addition, information from the electronic employment application 1 is typically transferred to a human resources information system 3. The data transferred to the human resources information system 3 is then transferred to the payroll feed 5. The payroll feed 5 is the part of the present invention that controls an employees pay, pay grade, full-time/part-time status, and other payroll related data. Preferably, payroll feed 5 transfers automatically to the human resources employment system 2 updated employee demographic and payroll data. The data transferred from the payroll feed 5 to the human resources employment system 2 preferably overwrites any data previously submitted from the electronic employment application 1. As shown if FIG. 1, the payroll feed 5 can be connected to a VOE 6, which verifies and double checks information in the payroll feed 5. VOE stands for verification of employment.

As shown in FIG. 1, human resources employment system 2 is a computer based system and product that is comprised of several subsystems including a program utility, a generic forms database, a programmed forms database, a reports database, a virtual notification system, an unemployment database, and an employee demographic database. The program utility is essentially a software program that allows the employer to access the various databases and program the desired human resources and unemployment forms. The unemployment database is a software program and database that allows the employer, an employer representative, or a third party to respond to any unemployment claims that are filed by terminated employees. The generic forms database is a computer based database that contains numerous generic human resources and unemployment forms that would typically be used by an employer. These forms would include 1-9, leave of absence, performance evaluation, disciplinary action, termination, exit interview, background check, and unemployment claims. The employer preferably, selects the generic forms it wishes to use from the generic forms database, programs and personalizes the forms using the program utility, and then stores the programmed and personalized forms in the programmed forms database. In addition to programming the forms with what demographic and substantive data to collect, the forms are preferably programmed with new hire home state reporting 21 requirements, tutorials, and legal flags. When an employer representative needs to use a specific form for a specific human resources or unemployment event, he or she uses a computer to access the human resources employment system and uploads a blank copy of a programmed and personalized form. The blank copy of the form typically has two types of data fields that must be filled out by the employer representative: employee demographic data fields and substantive data fields. The employee demographic data is preferably stored within the employee demographic data base. The human resources employment system 2 preferably pre-populates the employee demographic data fields in the uploaded blank form. This saves the employer representative the time and effort of having to manually use the computer keyboard to type in the employee demographic data. The employee demographic data includes employer demographic data as well, and the employer demographic data is pre-populated into the forms as desired. The employer representative then uses the human resources employment system 2 to complete the substantive data fields of the uploaded form. The tutorials and legal flags that are preferably programmed into the forms, aid the employer representative in filling out the uploaded form as correctly and accurately as possible. After the uploaded form's substantive data fields are accurately filled in and complete, the form is preferably printed out and placed on the electronic mark capture clipboard 4.

The electronic mark capture clipboard 4 is of the type known in the art to capture signatures simultaneously on a paper document and on an electronic document. The electronic mark capture clipboard 4 requires the use of an ink-magnet pen. The ink-magnet pen marks the paper copy of the printed out form. Additionally, the magnet part of the pen creates the same mark on the electronic copy that appears on the paper copy. The electronic mark capture clipboard 4 is programmed to recognize the specific form that is uploaded, and to interact with the human resources employment system 2, to capture all marks, notes and signatures made to the paper form while it rests on the electronic mark capture clipboard 4. Preferably the electronic mark capture clipboard 4 is large enough to allow a standard letter or legal size piece of paper to rest on it. The use of an electronic mark capture clipboard in filling out a human resources or unemployment form solves the problem of capturing all of the notes and the signature of the parties involved in completing that form. Moreover, it solves this problem without substantially deviating from what employees expect when they are involved with a human resources or unemployment event. Employees expect to be able to fully read and evaluate exactly what they are signing. Additionally, employees expect to sign the form, and to witness the employer representative signing the form. Employees are often distrustful and hesitant to merely sign an electronic keypad at the time of an important human resources event. Because the employee would not be able to fully view what they are signing, his or her suspicion may be justified. Additionally, an employee may completely balk at signing a form using an electronic PIN because they may not remember the PIN or they may even refuse to recall at that time what their PIN is, even if they actually do remember it. Further, that employee may no longer have an active PIN or may have never been given a PIN. The use of the electronic mark capture clipboard 4 allows the employee to fully view what they are signing, to witness that the employer representative signs it, and to immediately keep the ink and paper copy of the form for his or her records. Finally, the use of the electronic mark capture clipboard 4 preserves the “across-the-desk” formality between the employee and the employer representative. Although the electronic mark capture clipboard 4 is tethered, either physically or wirelessly, to the computer that has the uploaded electronic copy of the form on it, the employer representative can hand, across-the-desk, the electronic mark capture clipboard 4 to the employee for review, notation, and signature. Most importantly, the employer has an accurate and complete electronic document detailing the human resources or unemployment event that was just executed.

After the employee and the employer representative have made any final notations to and signed the printed form, the electronic copy of the form is locked. In addition to any date notations made by the employee and the employer representative prior to locking the form, the electronic copy of the form is preferably date stamped when it is locked. Preferably, the printed form is given to the employee for his or her personal records. As shown on FIG. 1, the human resources employment system generates several types of forms that are shared with an employee during a human resources or unemployment event, including, I-9 form 7, employee handbook release form 8, other custom forms as requested by employer 9, employee leave of absence form 10, performance evaluation form 11, employee disciplinary action form 12, employee termination form 13, employee exit interview form 14, health and insurance providers notification 15, hiring tax incentives 16, background checks 17, and drug testing 18. It should be clear that this is a limited list of the most common types of forms, and that numerous other types of human resources and unemployment forms are available and used in other embodiments of the present invention. Often, the health and insurance providers notification 15, hiring tax incentives 16, background checks 17, and drug testing 18 forms are request forms that are sent “out to third party” 19 with a response requested. If a response to the request is sent back to the employer, the response is filed in the same manner as the other executed forms, as discussed below.

As shown in FIG. 1, the human resources employment system 2 also comprises an electronic file drawer 20. The locked electronic forms and responses to the request forms are stored in the electronic file drawer 20 by employee name, social security number, or other employee demographic data. Preferably the human resources employment system 2 is programmed to allow select employer representatives and third parties to access the electronic file drawer 20 in order to obtain the most up to date information regarding an employee's employment status.

Before the locked forms are stored in the electronic file drawer 20, the forms are preferably, shared with select and pre-programmed employer representatives or departments such as, human resources, payroll, upper level management, or the legal department, via the virtual notification system. The virtual notification system preferably notifies the appropriate employer representatives through a hyperlink embedded in an email. However, the virtual notification system can notify the employer through a variety of means including an attached document in an email, an email, an electronic calendar reminder, an instant messaging message, or any other type of electronic notification system. The virtual notification system ensures that the proper department and personnel are notified when an important, or even routine, human resources or unemployment event occurs. This early notification allows the employer to catch as soon as possible any mistakes made on the forms, and prepare for follow up events, such as an unemployment claim. This virtual notification system may also be programmed to notify employer representatives when entire forms or specific data fields in forms will expire.

The human resources employment system 2 preferably allows the employer representative who completes a specific form to share electronically the form with other employer representatives before the form is shared with the employee. This allows the other employer representatives to comment on, or even edit, the form so that it is more accurate. This sharing also allows the other employer representatives to know that an important human resources event will soon take place, and to prepare for such an event. This sharing preferably occurs via the virtual notification system.

In addition, the human resources employment system 2 allows the employer representative to attach additional documents to the forms before they are stored in the electronic file drawer 20. These attached additional documents are accessible to employer representatives and third parties who are granted access to the electronic file drawer 20.

The human resources event may be an unemployment claim filed by a recently terminated employee. The unemployment claim is preferably directed to third party provider, but can be received and processed by the employer itself. Third party providers and employers have a limited time to respond to unemployment claims. As shown in FIG. 1, the unemployment claim responder can access the human resources employment system 2, the electronic file drawer 20, and the payroll feed 5 in order to obtain the most up to date information regarding the employee that filed the unemployment claim. The unemployment claim responder has all of the necessary information needed to appropriately respond to the unemployment claim if he or she has access to the electronic file drawer 20. The unemployment claim does not need to contact the human resources department or the employee's immediate supervisor to discover what happened when the employee was terminated. The forms available in the electronic file drawer 20 contain all the necessary information. Moreover, because the form was preferably filled out with the aid of tutorials and legal flags, and the form was shared with additional employer representatives before and after it was signed by the employee, there is a very good chance that the forms were filled out as accurately as possible. The unemployment claim responder uses the unemployment database to respond to the unemployment claim.

As shown in FIG. 1, the unemployment claim responder preferably creates an unemployment insurance claims record 22. If a hearing occurs, the unemployment claim responder preferably creates an unemployment insurance hearings record 23. If the employer is charged for the unemployment claim, the unemployment claim responder preferably creates an unemployment insurance charge record 24. As shown in FIG. 1, at the conclusion of the unemployment claim, the unemployment insurance claims record 22, the unemployment insurance hearings record 23, and the unemployment insurance charge record are stored in the electronic file drawer 20. The unemployment claim responder also preferably creates an insurance tax 25 record and any necessary unemployment insurance data reports 26.

All of the data fields of the forms stored in the electronic file drawer are preferably available to be accessed independently of the form and compiled into a variety of reports. These types of reports are very useful to management in forecasting future human resources and unemployment events and the nature of such events. The report data and reports generated are stored in the reports database.

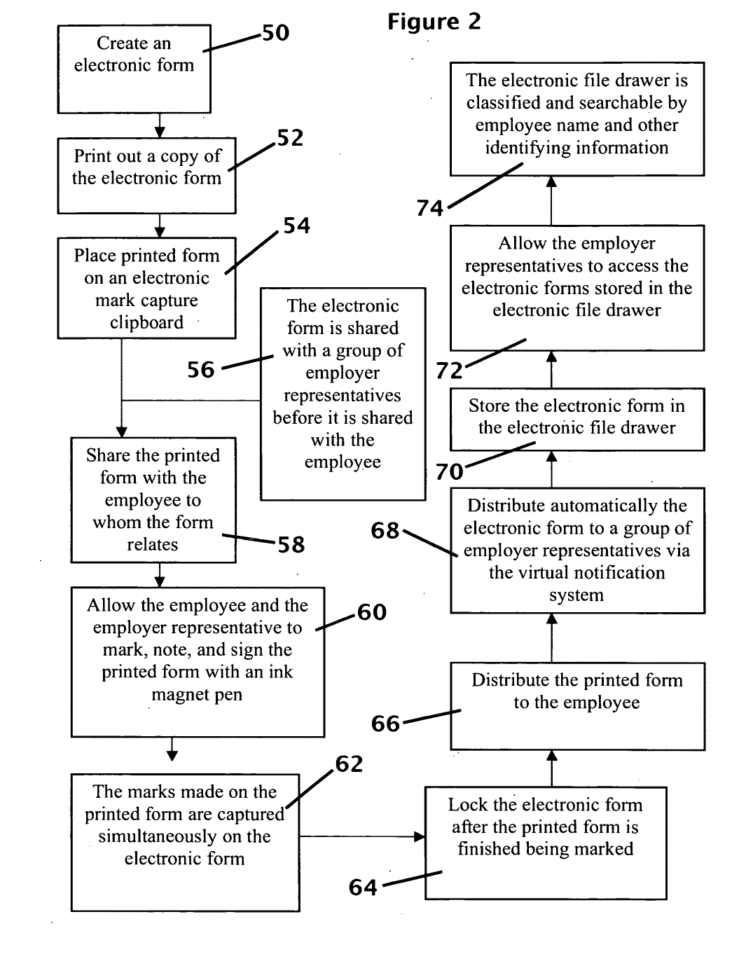

FIG. 2 illustrates in flow-chart diagram form, one embodiment of the present invention. The embodiment of the present invention shown in FIG. 2 is a computer based or aided system or method for capturing simultaneously a human resources event on a paper and ink form and an electronic form. As shown in FIG. 2, the system and method of one embodiment of the present invention preferably starts with the creation of a human resources or unemployment electronic form 50. The electronic form is created with the aid of a computer. In this example, the next step is to print out a copy of the electronic form 52. The printed form is placed on an electronic mark capture clipboard 54. Preferably the electronic copy of the form is shared with a group of additional employer representatives before the printed form is shared with the employee 56. The printed form is then shared with the employee to whom the form relates 58. The employee and employer representative are allowed to mark, note, and sign the printed form with an ink magnet pen 60. The marks made on the printed form are captured simultaneously on the electronic form 62, which is visible on the monitor of the computer that is connected to the electronic mark capture clipboard. The electronic form is locked after the printed form is finished being marked 64. Preferably, the printed form is distributed to the employee 66. In this embodiment of the present invention, the electronic form is automatically distributed to a preprogrammed group of employer representatives via the virtual notification system 68. The electronic form is stored in the electronic file drawer 70, and employer representatives are allowed access to the electronic form as it is stored in the electronic file drawer 72. The electronic file drawer is preferably classified and searchable by employee name or other employee demographic information 74, such as social security number or a unique employee number.

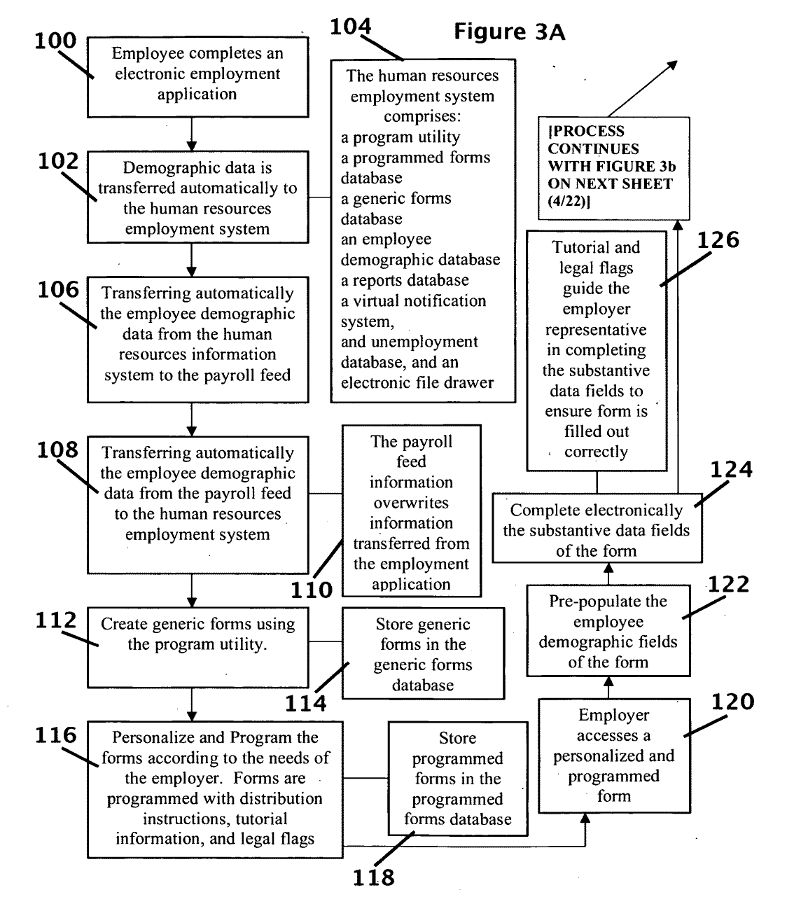

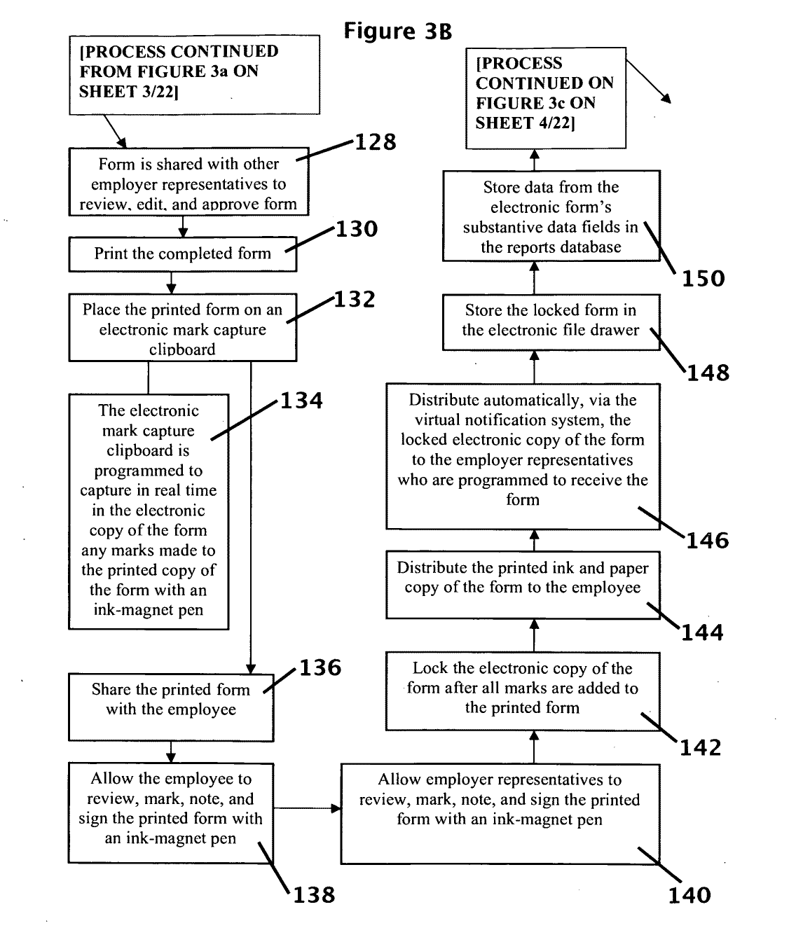

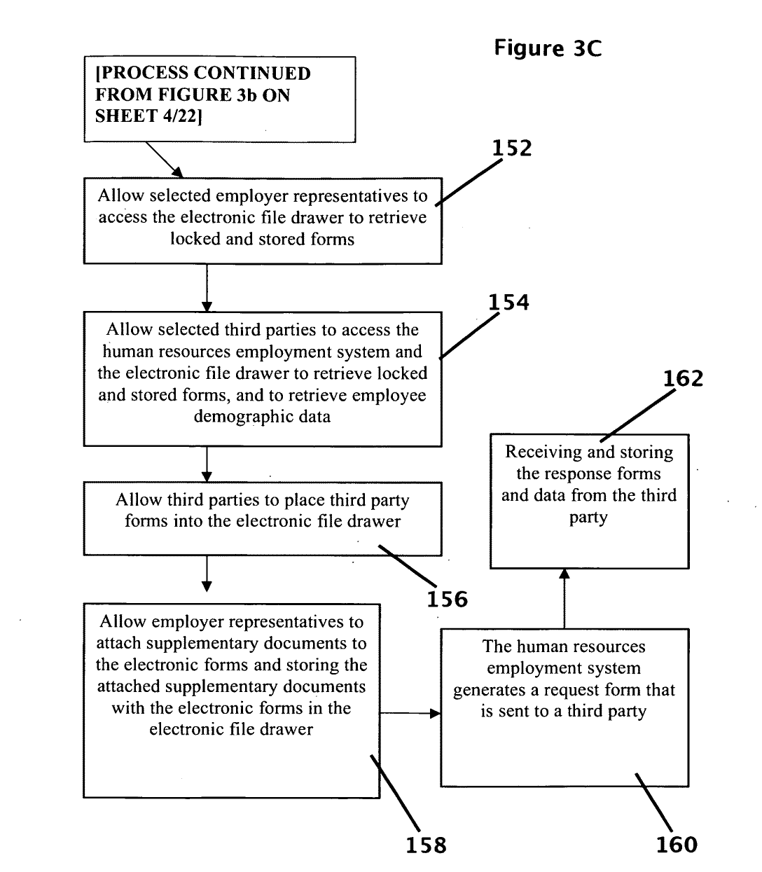

FIG. 3 illustrates in flow-chart diagram form, one embodiment of the present invention. FIG. 3 depicts a preferred embodiment and includes many steps that may not be necessary to successfully practice the system and method of the present invention. An employee or a designated employee representative completes an electronic employment application 100. The demographic data from the electronic employment application is preferably transferred automatically to the human resources employment system 102. The employee demographic data may be transferred manually without deviating from the scope of the present invention. The human resources employment system comprises a program utility, a programmed forms database, a generic forms database, an employee demographic database, a virtual notification system, an unemployment database, and an electronic file drawer 104. The unemployment database allows the employer, an employer representative, or a third party to respond to any unemployment claims that are received. The employee demographic data is transferred, or is otherwise originally inputted, into the human resources information system. The employee demographic data is transferred automatically from the human resources information system to the payroll feed 106. The employee demographic data may be transferred manually without deviating from the scope of the present invention. The employee demographic data is transferred automatically from the payroll feed to the human resources employment system 108. The employee demographic data may be transferred manually without deviating from the scope of the present invention. The employee demographic data transferred from the payroll feed overwrites the information that was transferred from the employment application 110. The employee demographic data that is transferred to the human resources employment system 108 is preferably presented in a logical wage data record layout and includes all employee demographic data that allows the employer to create various human resources forms for each specific employee. The employee demographic data fields preferably include: the hiring employer's Federal Identification Number; the employee's social security number; employee's name; the State postal code of where the employee works; the employer location code; frequency of when the employee is paid; optional pay type code, if necessary; payroll date; gross wage information in a standard two decimal format; optional pay term duration; hours worked; optional employment status information; separation or termination information, preferably in a coded format; the last day of employment; and the first day of employment. Although the employee demographic data preferably includes these listed data fields, the employee demographic data can range from as few as a single data field to millions of data fields. Although most of the employee demographic data is preferably transferred to the human resources employment system 108 automatically from the payroll feed, the data may be transferred manually. Additionally, the various employee demographic data fields can be populated in the human resources employment system 108 at the same time, or in a staggered manner. Because the human resources employment system 108 is frequently used to create human resources separation and termination forms, the separation and termination information is preferably available in a coded format. Consistent codes result in consistency and accuracy in the creation of human resources separation and termination forms. The separation and termination codes preferably include numerous sub-groups including, but not limited to: layoff; labor dispute; involuntary discharge; voluntary resignation; retirement; leave of absence; and other. Each sub-group preferably has numerous codes that enable an employer to choose a consistent, precise, and accurate separation and/or termination code for any and all separation events that may occur. The more codes that each sub-group has available, the more accurate and precise the separation and/or termination human resources form will be. Examples of separation and termination codes in the layoff sub-group include, but are not limited to: lack of work; indefinite or permanent layoff; location closing; relocation of job; temporary layoff; reorganization; job elimination; end of assignment; reduction in hours; and still employed. Examples of separation and termination codes in the labor dispute sub-group include, but are not limited to: strike—authorized; strike—work stoppage—unauthorized; lockout; wildcat; and refused to cross picket line. Examples of separation and termination codes in the involuntary discharge sub-group include, but are not limited to: unauthorized possession of company property; insubordination; use, possession or under the influence of alcohol or drugs; malicious damage of company property; fighting—assault; rudeness to customers; violation of company rules; excessive unexcused absences; chronic excused absences; excessive lateness; falsification of records; willful failure to perform job; violation of conditions of employment; not qualified for the job—no misconduct; unacceptable performance; physical inability to perform job; other—discharge; improper conduct; sleeping on the job; improper cash handling; no call/no show; failed drug screening test; leave of absence expired; probationary—misconduct; probationary—no misconduct; and not allowed to work out notice w/out pay. Examples of separation and termination codes in the voluntary resignation sub-group include, but are not limited to: to seek other employment/more money; to seek other employment/better opportunity; to seek other employment/dissatisfied with job; to seek other employment/other reasons; to accept other employment/more money; to accept other employment/better opportunity; to accept other employment/dissatisfied with job; to accept other employment/other reasons; to get married; to resume home duties; to leave geographic area; to attend school; personal reasons unrelated to job; transportation difficulties; mental or physical condition; pregnancy; unknown reasons; failure to return from leave of absence; other—voluntary resignation; walked off job; no call/no show/job abandonment; dissatisfied with job; conflict with primary employment; conflict with Supervisor; demotion; suspension. Examples of separation and termination codes in the retirement sub-group include, but are not limited to: mandatory retirement; voluntary normal retirement; voluntary early retirement; and disability—retirement. Examples of separation and termination codes in the leave of absence sub-group include, but are not limited to: leave of absence—Military; leave of absence—Disability; leave of absence—Other; and leave of absence—Family Leave Act (other than personal disability). Examples of separation and termination codes in the other sub-group include, but are not limited to: franchise acquisition; disciplinary suspension; refusal of work; unknown; other type separation; and death. If the separation and termination codes are transferred to the human resources employment system 108, when a specific human resources separation or termination form is needed, the employer representative who completes the form will have the option of completing the form with the precise, and accurate separation or termination code. Generic forms are created or loaded using the program utility 112. The generic forms, which represent those forms that the employer has requested to be part of its human resources system and product, are stored in the generic forms database 114. The forms are personalized and programmed with distribution instructions, tutorial information, and legal flags, according to the needs of the employer 116. The personalized and programmed forms are stored in the programmed forms database 118.

As shown in FIG. 3, the employer, or employer representative, accesses a personalized and programmed form 120, pre-populates the employee demographic fields of the form 122 using a computer, and then completes electronically the substantive data fields of the form 124. The tutorial and legal flags guide the employer representative in completing the substantive data fields to ensure the electronic forms is filled out correctly 126. The tutorials give the employer representatives, in real time, the information needed to fulfill the specific labor requirements that revolve around the specific human resources event for which the form is being completed. Depending upon the selected activity, there are over one thousand unique ways to populate the forms, and the tutorials help ensure the accurate capturing of employee data that is critical to protecting an employer's rights in the labor arena. When the employer is completing explanations or groups of text within a specific form, the present invention will flag any typed response, explanation, action, or comment that is not appropriate for the human resources or unemployment event for which the form is being completed. In addition to the flag, there is a suggested replacement that directs the employer representative to correctly describe the action being observed or taken with the employee involved in the human resources or unemployment event. As stated previously, when the forms are first programmed, the state in which the form is to be used is entered. This allows the present invention to designate and guide the employer representative in completing the form with the unique and specific characteristics of that state's employment laws. The electronic form may be shared with other employer representatives to review, edit, and approve 128.

FIG. 3 shows that the completed electronic form is printed out 130, and placed on an electronic mark capture clipboard 132. The electronic mark capture clipboard is programmed to capture in real time in the electronic copy of the form any marks made to the printed copy of the form with an ink-magnet pen 134. The electronic mark capture clipboard is preferably large enough to handle legal or letter size forms, but can be any size that can easily capture a signature and date. The printed form, as it rests on the electronic mark capture clipboard, is shared with the employee 136, and the employee is allowed to review, mark, note, and sign the printed form with an ink-magnet pen 138. The employer representative is also allowed an opportunity to review, mark, note, and sign the printed form with an ink-magnet pen 140. After all the marks are added to the printed copy of the form, the electronic copy is locked 142. The locked electronic form is preferably date stamped automatically and searchable by the date stamp after the form is stored. The printed ink and paper copy of the form is preferably distributed to the employee immediately after the electronic copy is locked 144. The virtual notification system then distributes automatically the locked electronic copy of the form to a group of pre-programmed employer representatives 146. Preferably, the form is available to the notified party via a hyperlink that when clicked on will display a copy of the form that was just completed. This virtual notification system solves numerous time sensitive issues that are very poorly executed by prior art products, systems and methods. For example, if the Payroll department is notified via the virtual notification system, Payroll will be able to cut final checks timely, rather waiting for the supervisor to process paperwork of a termination, leave, or other event. Moreover, the virtual notification system can also be programmed to calendar future actions that must be taken with respect to a specific form or expiration event.

FIG. 3 shows that the locked form is stored in the electronic file drawer 148. The substantive data from the electronic form's substantive data fields is separately storable in the reports database 150. The data stored in the reports database may be compiled into a variety of reports. These reports are also stored in the reports database. Selected employer representatives are allowed to access the electronic file drawer to retrieve locked and stored forms 152. Selected third parties are allowed to access the human resources employment system, and the electronic file drawer, to retrieve locked and stored forms, and to retrieve employee demographic data 154. Some of the third parties are also allowed to place third party forms into the electronic file drawer 156. Employer representatives are allowed to attach supplementary documents to the electronic copy of the forms and store them, with the electronic copy of the forms, in the electronic file drawer 158.

As shown in FIG. 3, the human resources employment system preferably generates a request form that is sent to a third party 160. The request often requires the third party to prepare a response. The third party response forms are preferably received and stored in the electronic file drawer or another human resources employment system database 162.

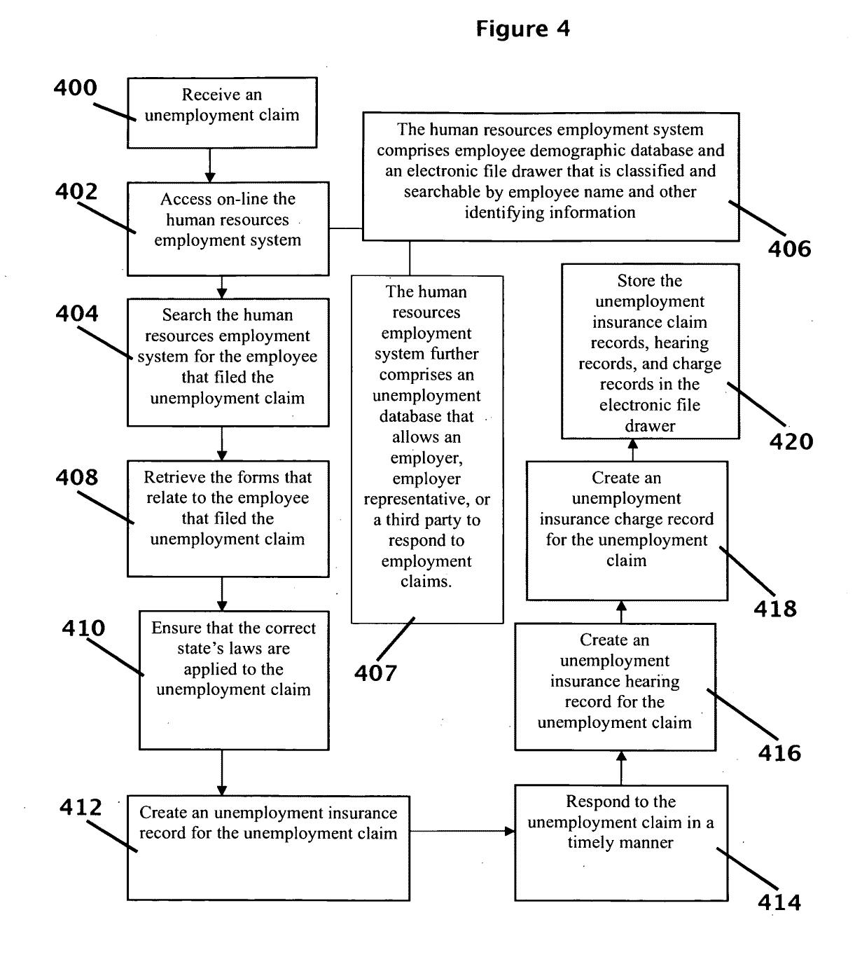

FIG. 4 illustrates in flow-chart diagram form, one embodiment of the present invention. The embodiment of the present invention shown in FIG. 4 is a computer based or aided system or method for handling unemployment claims in a precise and efficient manner. The system or method is preferably practiced on-line in a server based intranet or internet platform. As shown in FIG. 4, the present invention may be a system or method that begins with an employer or a third party provider contracted by the employer receiving an unemployment claim that was filed by a terminated employee 400. An employer representative or the third party provider accesses on-line the human resources employment system 402 to search for information about the employee that filed the unemployment claim and the circumstances of the termination 404. The human resources employment system comprises an employee demographic database and an electronic file drawer that are classified and searchable by employee name and other identifying information, such as a social security number or unique employee ID 406. The human resources employment system further comprises an unemployment database 407. The unemployment database allows the employer, employer representative, or a third party to respond to any unemployment claims that are received. The employer representative or third party provider retrieves the information and forms that relate to the employee that filed the unemployment claim 408. Ensure that correct state's laws are applied to the unemployment claim 410. Create an unemployment insurance record for the unemployment claim 412, and respond to the unemployment claim in a timely manner 414. The unemployment database is the system that is used to respond to the unemployment claim. If necessary the employer representative or third party provider preferably creates an unemployment insurance hearing record 416 and an unemployment insurance charge record 418 for the unemployment claim. The unemployment insurance claim records, hearing records and charge records are preferably stored in the electronic file drawer under the employees name or other demographic data field 420.

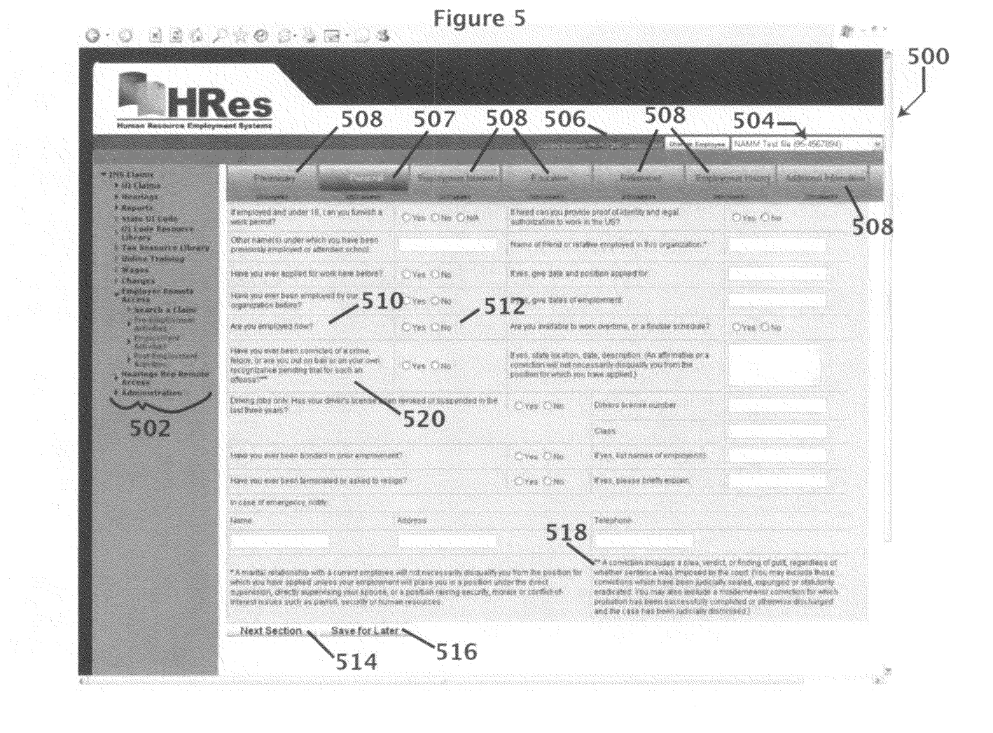

FIG. 5 is a screen shot from an on-line program that has accessed the electronic employment application page for one embodiment of the invention. A web page 500 is shown that displays many of the parts of the constituent parts of the invention. Specifically web page 500 shows the site-map-tree 502. Site-map-tree 502 allows an administrator to easily navigate between the dozens of web pages that comprise this embodiment of the present invention. Web page 500 shows the specific employer 504 and employee 506 that is currently being accessed. The employer representative that is accessing the web pages of the present invention can switch between employees or between employers. Multiple employers may be accessible because, although many companies have a centralized Human Resources department, they can also have numerous wholly owned subsidiary companies that have their own unique tax identification number. FIG. 5 primarily shows the electronic employment application of the present invention. The electronic employment application on web page 500 has seven tabs 507 and 508 that the potential employee must fill out. The potential employee clicks on the next tab to switch between tabs. The tab array ensures that the form is accurately and completely filled out with all of the potential employee's demographic information. FIG. 5 shows that the “personal” tab 507 is currently open. The “personal” tab 507 asks the potential employee to complete several data fields, including “Are you employed now?” 510. The employee uses the keyboard or mouse attached to the computer displaying webpage 500 to check either “Yes” or “No” 512. When all of the tabs 507 and 508 are complete, the employee clicks on “Next Section” 514 or “Save for Later” 516. FIG. 5 shows one embodiment of the tutorials of the present invention. The double asterisk (“**”) 518 gives the potential employee more information about answering the conviction field 520. The conviction field 520 is not asked by employers in all fifty states, so webpage 500 is also an example of a web page form that has been programmed and personalized to the specific needs of the employer 504 that is using the present invention. Preferably all of the forms of the present invention have similar user interface designs and are completed in manners similar to what was just described above.

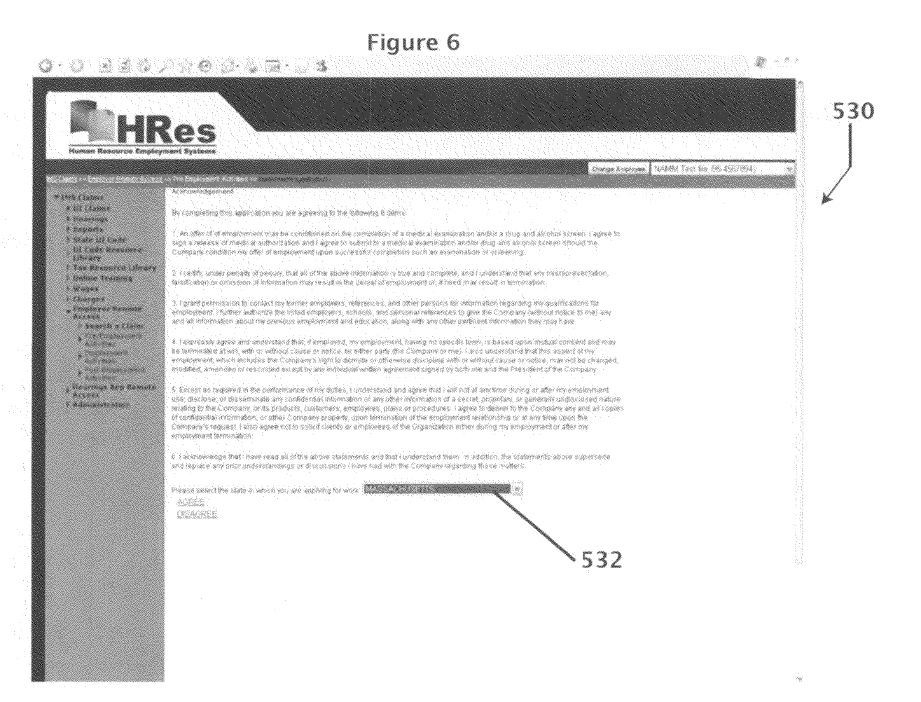

FIG. 6 is a screen shot from an on-line program that has accessed the electronic employment application choice of state page for one embodiment of the invention. As shown in FIG. 6, web page 530 requests that a potential employee filing out an electronic employment application chose in what state they expect to be employed. The employee has selected “MASSACHUSETTS” 532. Any forms created and pre-populated with information by the human resource employment system of the present invention will now take into account the employment laws of Massachusetts in guiding an employer representative in completing the form. This is important for the tutorials, legal flags, and other systems of the present invention.

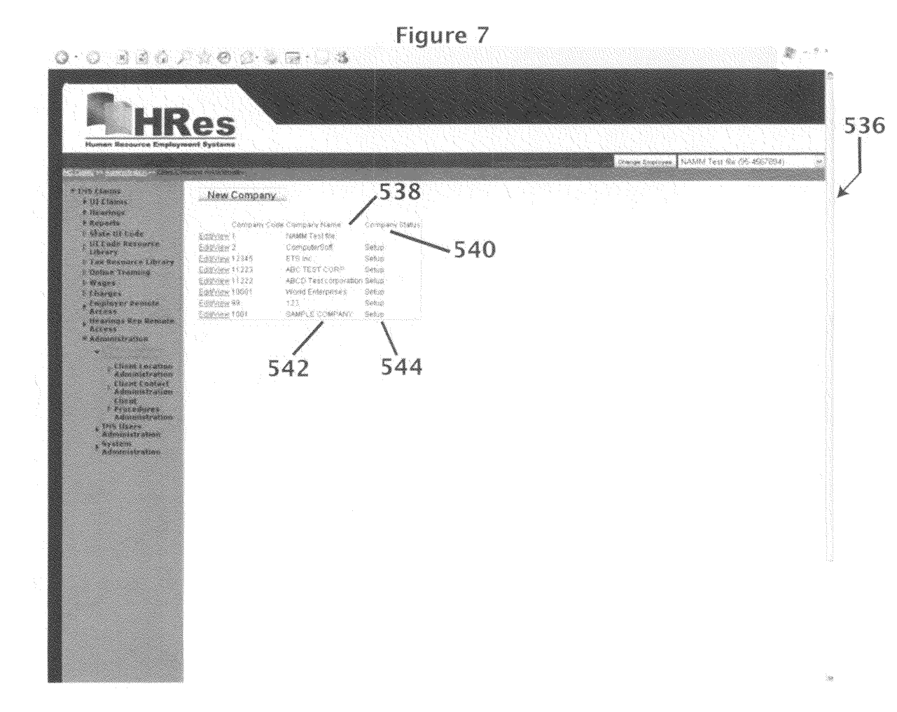

FIG. 7 is a screen shot from an on-line program that has accessed the forms creation page of the program utility for one embodiment of the invention. As shown in FIG. 7, webpage 536 shows a new employer's forms being created by the present invention. New employer “NAMM Test file” 538 is shown as not set up in “Company Status” data field 540. Old employer “SAMPLE COMPANY” 542 is shown as “Setup” in “Company Status” data field 544. After the new company “NAMM Test file” 538 has selected what generic forms it wants access to, and these generic forms are personalized and programmed to the specific needs of “NAMM Test file” 538, the “Company Status” will be changed to read “Setup” in data field 540.

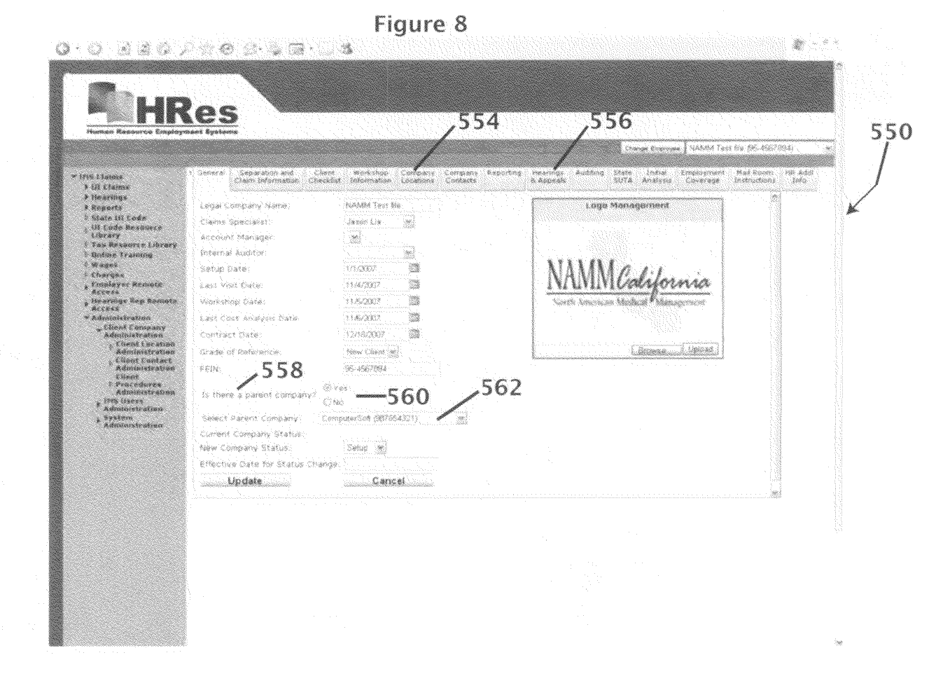

FIG. 8 is a screen shot from an on-line program that has accessed the forms creation page of the program utility for one embodiment of the invention and shows the employer demographic information being collected. One embodiment of the present invention creates personalized and programmed forms tailored to the needs of a specific employer. In order to ensure that the forms have the correct employer demographic information, the employer's demographic information is collected in webpage 550. As shown in FIG. 8, webpage 550 has numerous tabs, including “General” 552, “Company Locations” 554, and “Hearings & Appeals” 556. The information collected in the tabs allows the creation of forms that accomplish exactly what the employer needs. As shown in webpage 550, the “General” 552 tab asks such questions as “Is there a parent company? 558. The employer has selected “Yes” 560, and has selected parent company “ComputerSoft (987654321) 562. The employer demographic data entered is preferably available to pre-populate the non-substantive data fields of the forms.

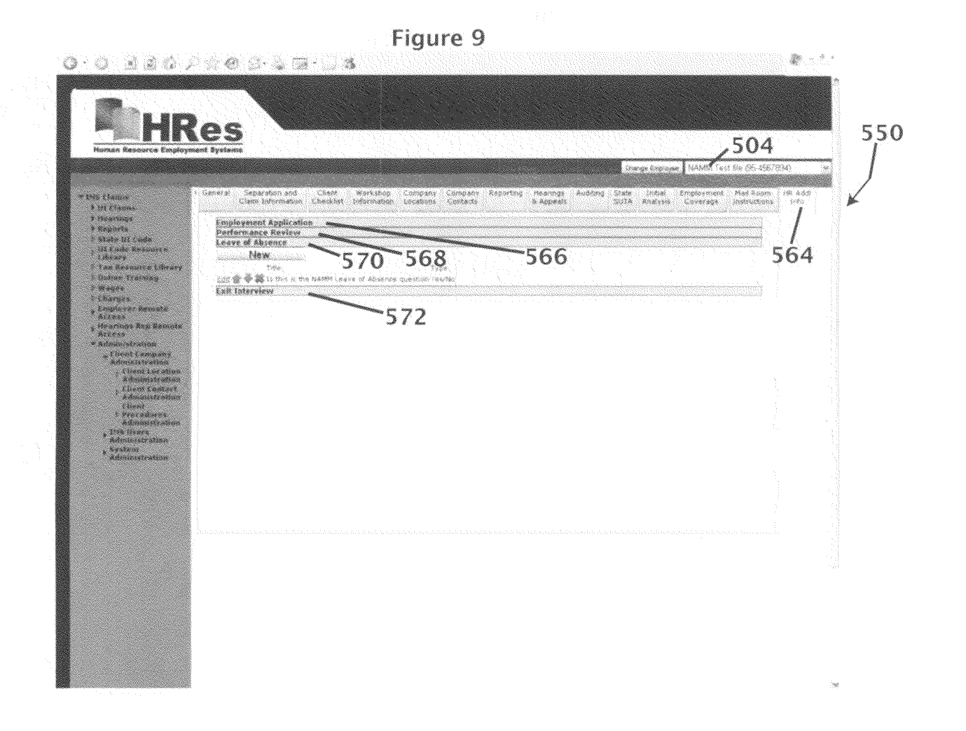

FIG. 9 is a screen shot from an on-line program that has accessed the forms creation page of the program utility for one embodiment of the invention and shows the selection of forms in the generic forms database to be programmed and personalized. As shown in FIG. 9, web page 550 is now on tab “HR Addl Info” 564. The “HR Addl Info” 564 tab requires the employer to select what forms it wants to program and personalize. As shown in FIG. 9, employer “NAMM Test file” 504 has selected the forms, “Employment Application” 566, “Performance Review” 568, Leave of Absence” 570, and “Exit Interview” 572. There is no minimum or maximum number of forms that must be selected.

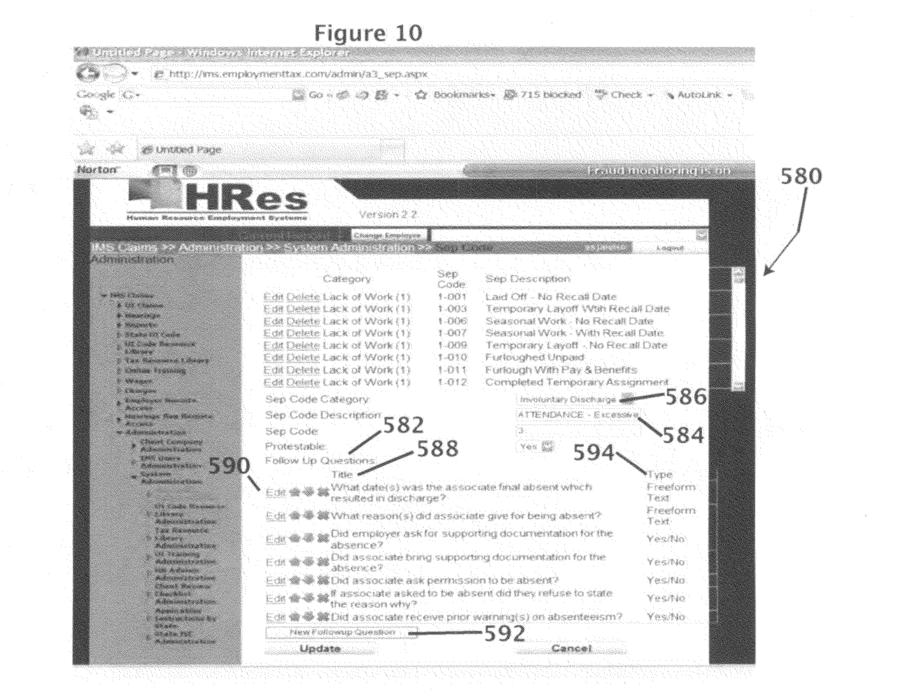

FIG. 10 is a screen shot from an on-line program that has accessed the forms creation page of the program utility for one embodiment of the invention and shows a form being programmed and personalized. As shown in FIG. 10, webpage 580, the program utility is being used to personalize and program the termination form for a specific employer. Specifically, the employer is choosing what “Follow up Questions:” 582, the employer representative must complete if the employer representative is terminating the employer for excessive absences. Data field 584 displays that the questions relate to “ATTENDANCE—Excessive.” The text of the field continues, but is not visible, and actually reads “ATTENDANCE—Excessive Absences.” Data field 586 displays the type of termination, and reads “Involuntary Discharge.” As shown in FIG. 10, the employer can: select generic questions under “Title:” 588; “Edit” 590 the question; create a “New Followup Question” 592; and select the nature or “Type” 594 of answer that will be required. After the employer has selected, programmed, and personalized all the forms that will be part of the human resources employment system, the forms are stored in the programmed forms database.

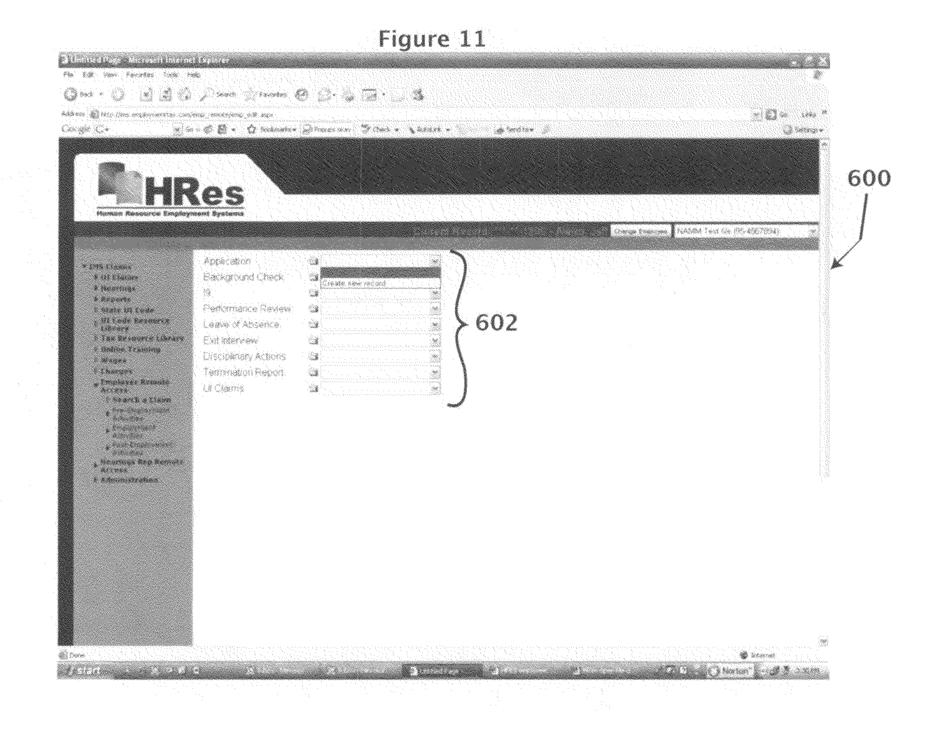

FIG. 11 is a screen shot from an on-line program that has accessed the programmed forms database for one embodiment of the invention. Webpage 600 is the programmed forms database and allows an employer representative to access the programmed forms. FIG. 11 shows that numerous programmed forms 602 are available, including an application, an 19, and an exit interview.

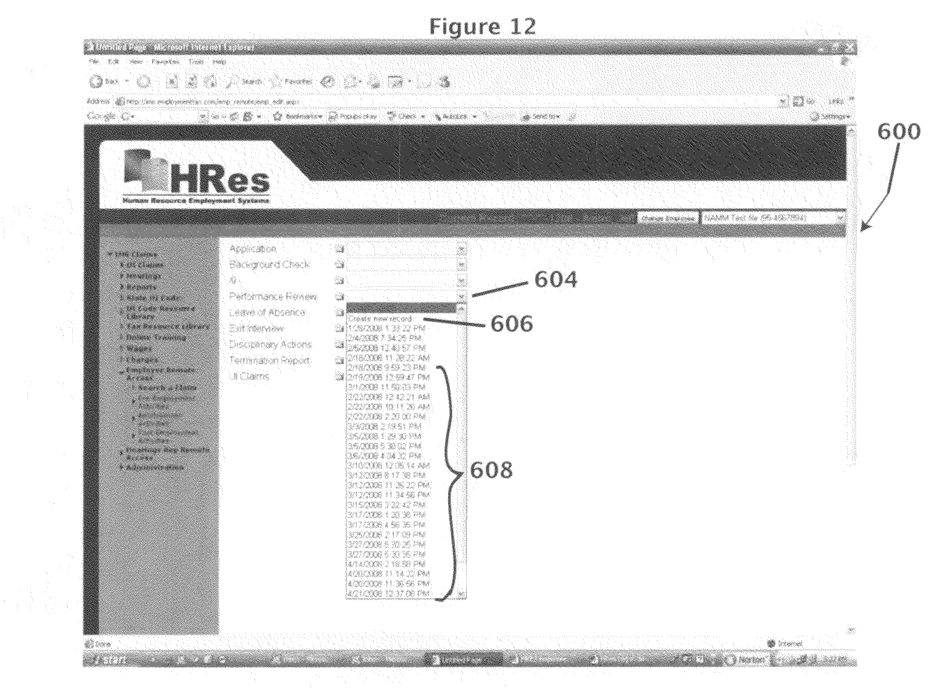

FIG. 12 is a screen shot from an on-line program that has accessed the programmed forms database for one embodiment of the invention. As shown in FIG. 12, the user of webpage 600 has clicked on the drop down menu for “Performance Review” 604. Normally the user will click on “Create new record” 606, which would pull up a new performance review form to be filled out. However, as shown in FIG. 12, the user can also use the programmed forms database to access previously completed performance reviews 608 based on the date the performance review was locked. This shows how the databases of the human resources employment system are interlinked and cross-functional.

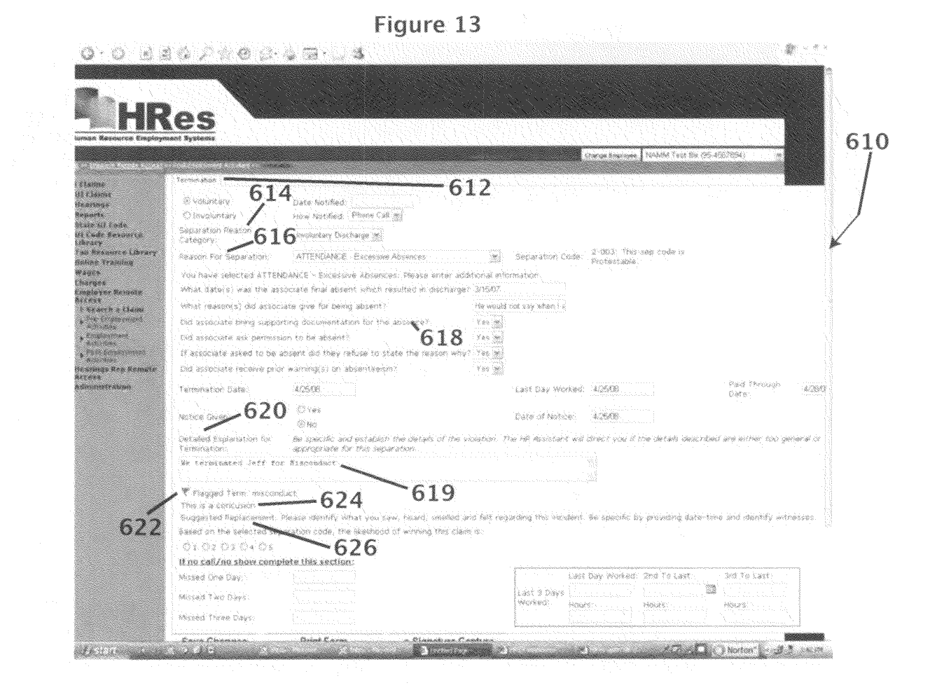

FIG. 13 is a screen shot from an on-line program that has accessed a webpage for one embodiment of the invention that is a specific, programmed, and personalized termination form and shows a legal flag. Web page 610 is a termination form 612. As shown in FIG. 13, the employer representative that accessed termination form 612 has numerous substantive data fields to complete. The employer and employee demographic data fields are pre-populated by the system, method, and product of the present invention. Webpage 610 requires the user to complete such substantive data categories as, “Separation Reason Category:” 614, and “Reason For Separation:” 616. Depending on what category and reason for the separation, the other substantive data fields may change. For example, the question “Did associate bring supporting documentation for the absence?” 618 would not be asked if the reason for separation was insubordination and the employer representative selected insubordination as the reason for separation. The follow up questions asked are specific to the category and reason for the separation. As shown in FIG. 13, termination form 612 allows the employer representative to add free text in data field 619, which is under “Detailed Explanation for Termination:” 620. The employer representative typed in the word “Misconduct” into data field 619. The present invention “Flagged Term: misconduct” 622. The term was flagged because “This is a conclusion” 624. The legal flag programming gives a “Suggested Replacement” 626. This legal flag programming, combined with the available tutorials, ensures that the forms are completed as accurately and completely as possible at the time of the human resources or unemployment event to which they are related.

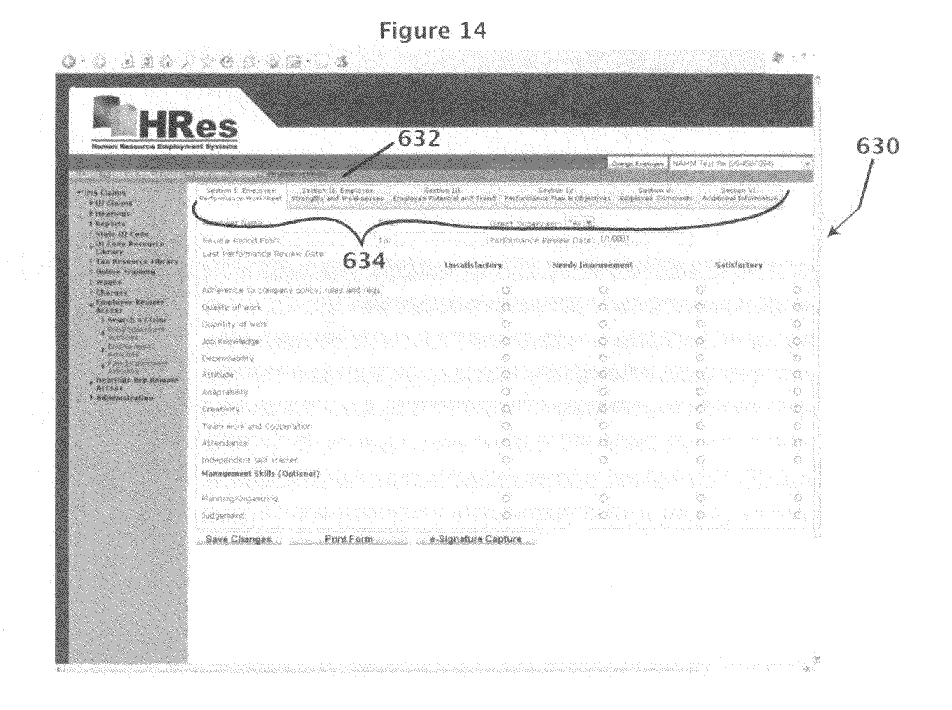

FIG. 14 is a screen shot from an on-line program that has accessed a webpage for one embodiment of the invention that is a specific, programmed, and personalized performance review form. Webpage 630 is an example of a performance review form 632. Like the termination form 612 shown in FIG. 13, performance review form 632 has numerous substantive data fields that must be completed by the employer representative. Additionally, performance review form 632 has several tabs 634 that must be completed before it is signed, locked, and stored. FIG. 14 is merely an example of the numerous types of forms that are available in the present invention. Further, it is not just human resources forms that are available, unemployment claim forms, unemployment insurance forms, and forms related generally to the human resources and unemployment fields are also a significant part of the present invention. The human resources and unemployment forms not shown as specific examples are accessed and completed in essentially the same way as the performance review form shown in FIG. 14 and detailed above.

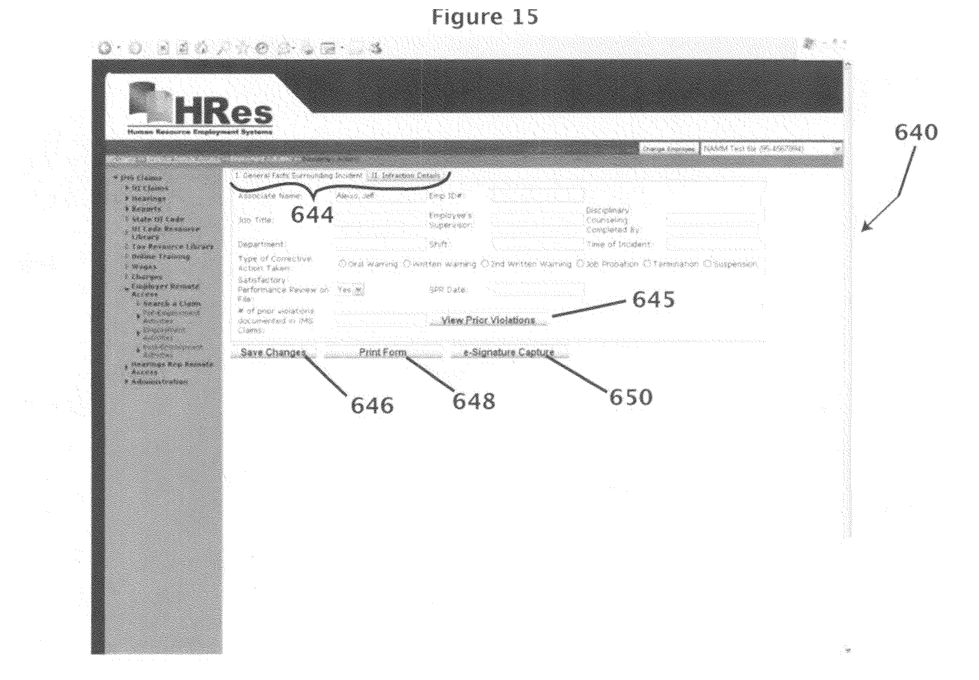

FIG. 15 is a screen shot from an on-line program that has accessed a webpage for one embodiment of the invention that is a specific, programmed, and personalized disciplinary action form. Webpage 640 is an example of a disciplinary action form 642. Similar to performance review form 632 shown in FIG. 14, disciplinary action form 642 has numerous substantive data fields and multiple tabs 644 that must be completed before it is signed, locked, and stored. Webpage 640 allows the employer representative completing the form to “View Prior Violations” 645. This is important if the employee has recently transferred or if the employee has a new supervisor. The ability to access past violation may be extremely helpful in determining the tone that should be taken for the current disciplinary action. Preferably, many of the different forms of the present invention have this type of cross-database access. As shown in FIG. 15, after the substantive data fields in disciplinary action form 642 are completed, the employer representative can click on “Save Changes” 646, “Print Form” 648, and “e-Signature Capture” 650. If the employer representative is sharing the completed form with additional employer representatives before discussing the form with the employee to whom the form relates, the form should be saved and sent to the additional employer representatives via the virtual notification system. When the form is ready to be shared with the employee, the form is printed and placed on an electronic mark capture clipboard. Before the employee begins marking, signing, dating, or otherwise noting the printed form with an ink-magnet pen, the employer representative should click “e-Signature Capture” 650.

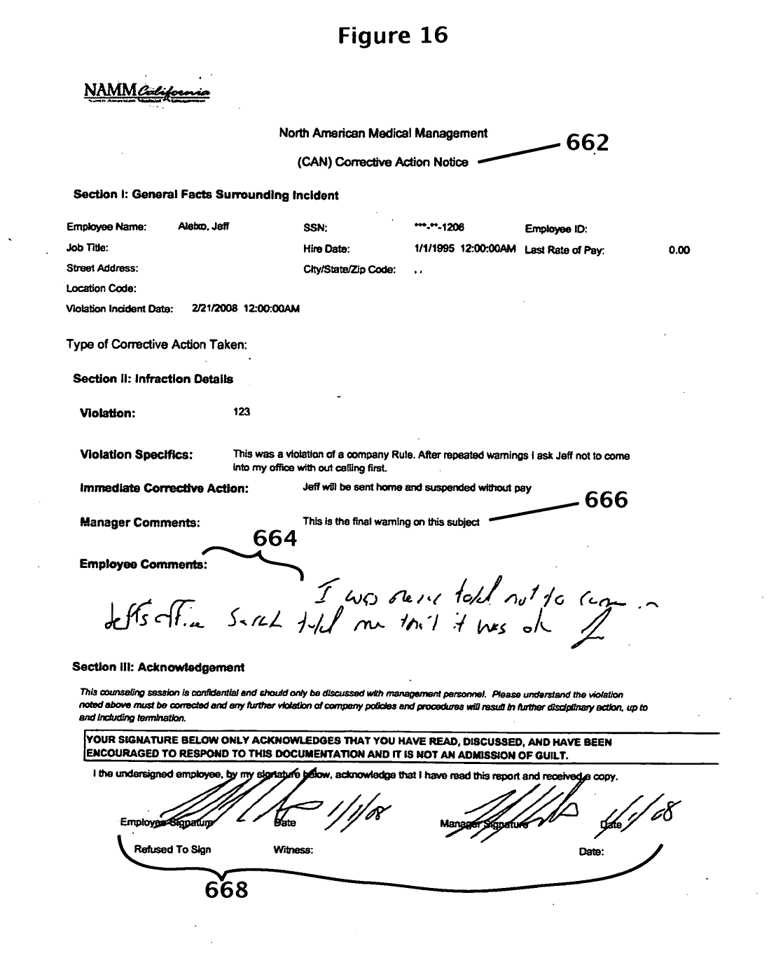

FIG. 16 is a printed disciplinary action form of one embodiment of the invention. As shown in FIG. 16, disciplinary action form 660 is a “Corrective Action Notice” 662. The employee to whom the form relates marked the disciplinary action form 660 with an ink-magnet pen in the “Employee Comments:” 664. Prior to disciplinary action form 660 being printed out the employer representative completed the substantive data fields of the form, including the “Manager Comments:” 666. As preferred, FIG. 16 shows that the “Manager Comments” 666 are typed, and the “Employee Comments:” 664 are hand written with the ink-magnet pen. Both the employer and the manager have signed and dated 668 disciplinary action form 660. The electronic copy of disciplinary action form 660 should not be marked until the employer representative clicks “e-Signature Capture” 660, shown in FIG. 15. The electronic copy of disciplinary action form 660 should not be locked until both the manager and employee have completed marking the printed copy of disciplinary action form 660.

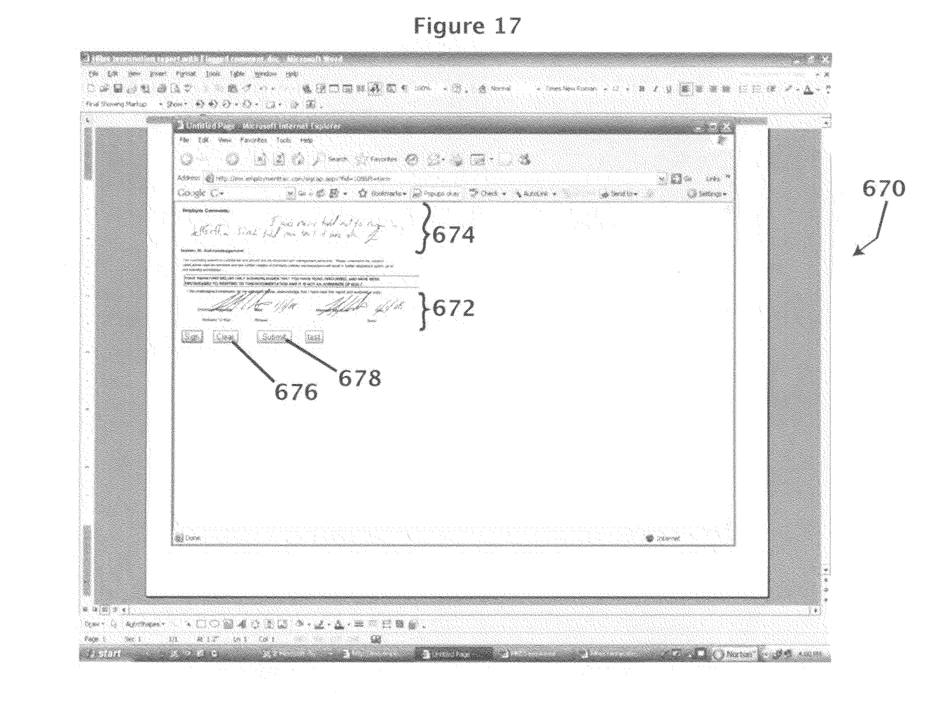

FIG. 17 is a screen shot from an on-line program that has accessed a disciplinary action form page for one embodiment of the invention that was signed with an electronic mark capture clipboard. As shown in FIG. 17, webpage 670 shows the electronic copy of disciplinary action form, which is essentially the electronic version of the printed copy of disciplinary action form 660 as shown in FIG. 16. As shown in FIG. 17, the signatures and dates 672 of both the manager and employee are captured electronically at the exact moment that they were written on the printed form. FIG. 17 also shows that the Employee Comments:” 674 are captured electronically at the exact moment that they were written on the printed form. If the marks made to the printed form are not appropriately and clearly captured electronically, the “Clear” 676 button may be clicked to clear the electronic form. After the employee and employer representative have completed marking the printed copy of the form, the “Submit” 678 button is clicked to lock the electronic copy of the form.

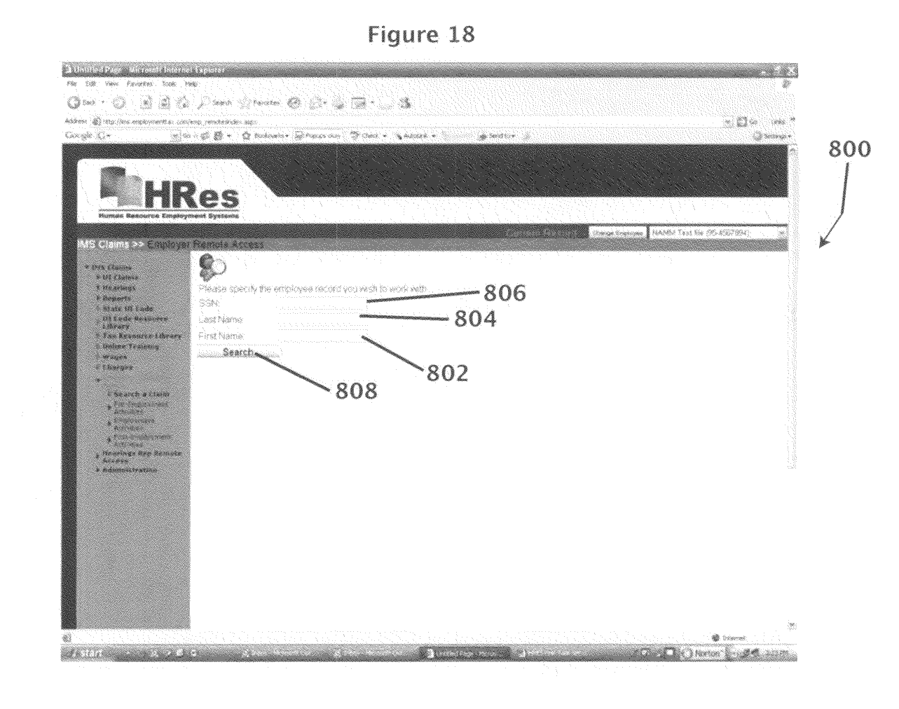

FIG. 18 is a screen shot from an on-line program that has accessed the electronic file drawer page for one embodiment of the invention. Webpage 800, as shown in FIG. 18, is the electronic file drawer main page. Preferably, the electronic file drawer is classified and searchable by employee name, social security number, or other employee demographic data. The embodiment of the present invention in FIG. 18, allows the user to search the electronic file drawer by an employee's first name 802, last name 804, or social security number 806. Additionally, the entire contents of the electronic file drawer may be browsed by clicking on “Search” 808.

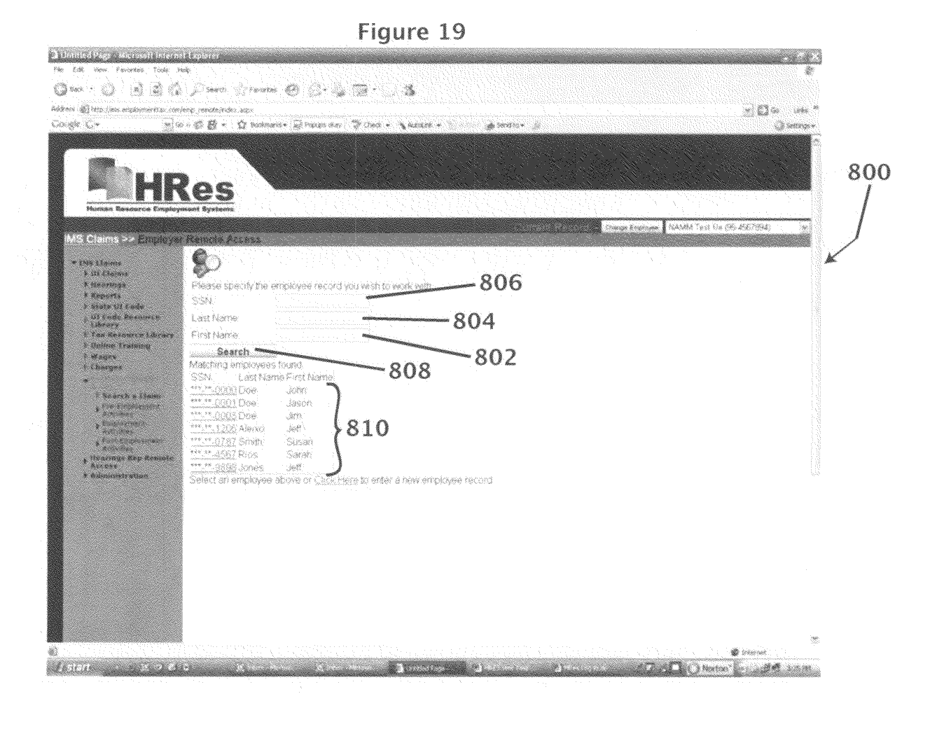

FIG. 19 is a screen shot from an on-line program that has accessed the electronic file drawer page for one embodiment of the invention. Webpage 800, as shown in FIG. 19, is the electronic file drawer after “Search” 808 has been clicked. When no information has been entered in the first name 802, last name 804, or social security number 806 fields, clicking on “Search” 808 brings up a list of employees 810 initially sorted by social security number. By clicking on a specific employee, all of the locked forms associated with that employee may be accessed.

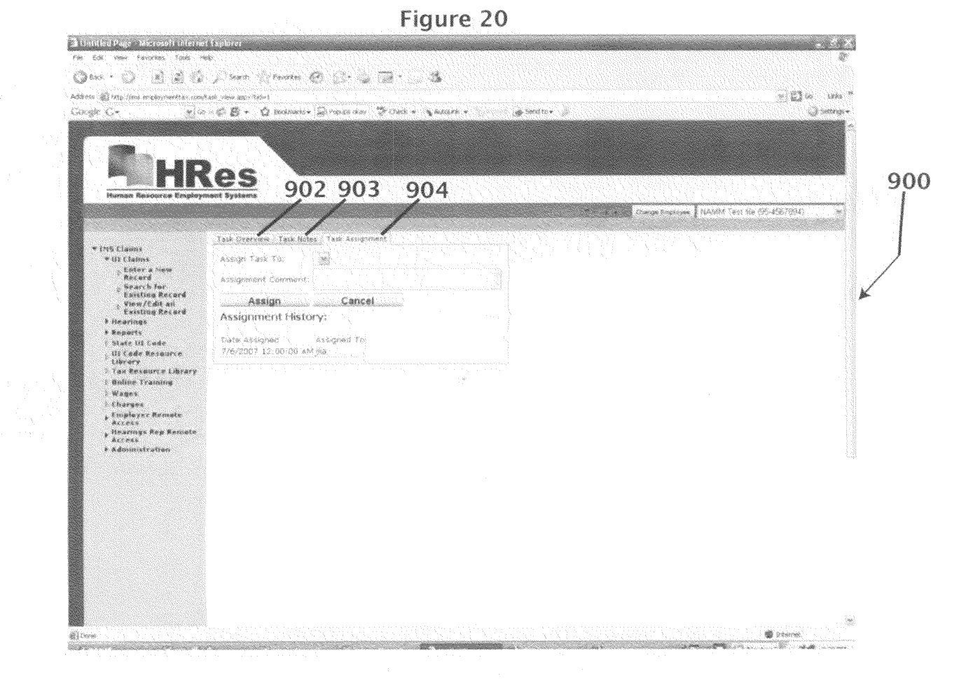

FIG. 20 is a screen shot from an on-line program that has accessed the virtual notification system page for one embodiment of the invention. The virtual notification system of the present invention alerts a group of employer representatives when a human resources or unemployment event has occurred. Preferably, the virtual notification system alerts the group of employer representatives by generating an email notification. The form or forms associated with the notification are attached to the email as an embedded hyperlink. When the notified employer representative clicks on the hyperlink, a copy of the actual form or forms appears. Preferably, the virtual notification system automatically notifies a pre-programmed group of employer representatives. However, as shown in FIG. 20, the virtual notification system may be accessed manually. Manual access to the virtual notification system is desirable to share completed, but unlocked forms, with a group of employer representatives. As shown in FIG. 20, webpage 900 is the start page for one embodiment of the virtual notification system. Webpage 900 has three tabs, “Task Overview” 902, “Task Notes” 903, and “Task Assignment” 904. As shown in FIG. 20, webpage 900 is open to “Task Assignment” 904. “Task Assignment” 904 allows an employer representative to select one or more additional employer representatives to share a completed electronic copy of a form.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A computer-aided method of managing human resources and unemployment forms comprising the steps of:
populating a human resources employment system with employee demographic data, wherein said human resources employment system is a software program comprised of a program utility, and an employee demographic database;
using said program utility to create a plurality of forms within said human resources employment system, wherein said plurality of forms have an one or more employee demographic fields, and wherein said plurality of forms have an one or more substantive data fields;
pre-populating electronically an one or more demographic fields of a specific form with said plurality of employee demographic data available from said employee demographic database;
completing electronically said one or more substantive data fields in said specific form;
printing said specific form, wherein said specific form is divided into a printed specific form and an electronic specific form;
placing said printed specific form on an electronic mark capture clipboard, wherein said electronic mark capture clipboard is programmed to capture in real time an one or more marks made to said printed specific form with an ink-magnet pen and simultaneously capture said one or more marks into said electronic specific form;
sharing said printed specific form with an employee to whom said specific form relates;
allowing said employee to mark said printed specific form with said ink-magnet pen; and
locking said electronic specific form after said printed specific form is finished being marked.

2. A computer-aided method of managing human resources and unemployment forms according to claim 1, wherein said human resources employment system further comprises a virtual notification system.

3. A computer-aided method of managing human resources and unemployment forms according to claim 2, further comprising:
programming said plurality of forms, by a form type, to be distributed automatically to an one or more employer representatives via said virtual notification system after said plurality of forms are locked.

4. A computer-aided method of managing human resources and unemployment forms according to claim 3, further comprising:
distributing said printed specific form to said employee; and
distributing said electronic specific form to said one or more employer representatives via said virtual notification system.

5. A computer-aided method of managing human resources and unemployment forms according to claim 4, wherein said human resources employment system further comprises an electronic file drawer.

6. A computer-aided method of managing human resources and unemployment forms according to claim 5, further comprising:
storing said electronic specific form in said electronic file drawer.

7. A computer-aided method of managing human resources and unemployment forms according to claim 6, wherein said human resources unemployment system further comprises a programmed forms database.

8. A computer-aided method of managing human resources and unemployment forms according to claim 7, further comprising:
storing said plurality of forms in said programmed forms database after said plurality of forms are programmed; and
accessing a specific form from said programmed forms database.

9. A computer-aided method of managing human resources and unemployment forms according to claim 8, further comprising:
allowing said one or more employer representatives to mark said printed specific form with said ink-magnet pen.

10. A computer-aided method of managing human resources and unemployment forms according to claim 9, further comprising:
allowing said one or more employer representatives to access said electronic file drawer to retrieve an one or more locked and stored electronic forms.

11. A computer-aided method of managing human resources and unemployment forms according to claim 10, further comprising:
allowing an one or more third parties to access said human resources employment system and said electronic file drawer to retrieve said one or more locked and stored electronic forms;
allowing said one or more third parties to access said human resources employment system and said electronic file drawer to retrieve said employee demographic data; and
allowing said one or more third parties to place an one or more third party forms in said electronic file drawer.

12. A computer-aided method of managing human resources and unemployment forms according to claim 11, wherein said electronic file drawer is classified and searchable by an individual employee, and wherein said employee demographic database is classified and searchable by said individual employee.

13. A computer-aided method of managing human resources and unemployment forms according to claim 12, further comprising:
personalizing said plurality of forms to conform to the needs of an employer;

14. A computer-aided method of managing human resources and unemployment forms according to claim 13, wherein said human resources employment system further comprises a generic forms database, and wherein said plurality of forms are stored in said generic forms database before they are personalized or programmed.

15. A computer-aided method of managing human resources and unemployment forms according to claim 15, wherein said plurality of forms are stored in said programmed forms database after said plurality of forms are personalized and programmed;

16. A computer-aided method of managing human resources and unemployment forms according to claim 15, further comprising:
programming said plurality of forms with a tutorial system that provides a real time legal guidance to said one or more employer representatives as to how to appropriately complete said one or more substantive data fields of said plurality of forms.

17. A computer-aided method of managing human resources and unemployment forms according to claim 16, further comprising:
programming said plurality of forms with a legal notification system that flags in real time an one or more inappropriate words in a comment that said one or more employer representatives enters into said plurality of forms, and suggests an one or more alternative words for said comment.

18. A computer-aided method of managing human resources and unemployment forms according to claim 17, wherein said human resources employment system further comprises a reports database.

19. A computer-aided method of managing human resources and unemployment forms according to claim 18, further comprising:
storing a plurality of substantive data from said substantive data fields in said reports database.

20. A computer-aided method of managing human resources and unemployment forms according to claim 19, further comprising:
sharing electronically said specific form with additional said one or more employer representatives before said specific form is shared with said employee to whom said specific form relates.

21. A computer-aided method of managing human resources and unemployment forms according to claim 20, further comprising:
allowing additional said one or more employer representatives to edit said specific form before said specific form is shared with said employee to whom said specific form relates.

22. A computer-aided method of managing human resources and unemployment forms according to claim 21, further comprising:
allowing said one or more employer representatives to attach an one or more supplementary documents to said electronic specific form, wherein said one or more supplementary documents are stored with said electronic specific form in said electronic file drawer after said electronic specific form is locked.

23. A computer-aided method of managing human resources and unemployment forms according to claim 22, wherein said specific form is a request form.

24. A computer-aided method of managing human resources and unemployment forms according to claim 23, further comprising:
sending electronically said request form to said one or more third parties;
receiving electronically a result form from said one or more third parties in response to said request form; and
storing said result form in said electronic file drawer.

25. A computer-aided method of managing human resources and unemployment forms according to claim 1, wherein said specific form is a request form.

26. A computer-aided method of managing human resources and unemployment forms according to claim 25, further comprising:
sending electronically said request form to said one or more third parties;
receiving electronically a result form from said one or more third parties in response to said request form; and
storing said result form in said electronic file drawer.

27. A computer-aided method of managing human resources and unemployment forms according to claim 24, wherein said electronic specific form is automatically date stamped at locking; wherein said human resources employment system further comprises an unemployment database; and wherein said unemployment database is used to respond to and manage an unemployment claim.

28. A computer-aided method of managing human resources and unemployment forms according to claim 27, further comprising:
completing an electronic employment application; and
transferring a plurality of employee demographic data from said electronic employment application to said human resources employment system.

29. A computer-aided method of managing human resources and unemployment forms according to claim 28, further comprising:
transferring a plurality of employee demographic data from said electronic employment application to said human resources information system;
transferring a plurality of employee demographic data from said human resources information system to a payroll feed; and
transferring a plurality of employee demographic data from said payroll feed to said employee demographic database, wherein said plurality of employee demographic data from said payroll feed overwrites said plurality of employee demographic data previously transferred from said electronic employment application.

30. A computer-aided method of managing human resources and unemployment forms comprising the steps of:
completing an electronic employment application;
transferring a plurality of employee demographic data from said electronic employment application to a human resources employment system, wherein said human resources employment system is a software program comprised of a program utility, a programmed forms database, a generic forms database, an employee demographic database, a reports database, a virtual notification system, an unemployment database, and an electronic file drawer, and wherein said electronic file drawer is classified and searchable by an individual employee, and wherein said employee demographic database is classified and searchable by said individual employee;
transferring a plurality of employee demographic data from said electronic employment application to a human resources information system;
transferring a plurality of employee demographic data from said human resources information system to a payroll feed;
transferring a plurality of employee demographic data from said payroll feed to said employee demographic database, wherein said plurality of employee demographic data from said payroll feed overwrites said plurality of employee demographic data previously transferred from said electronic employment application;
using said program utility to create a plurality of forms within said human resources employment system, wherein said plurality of forms have an one or more employee demographic fields, and wherein said plurality of forms have an one or more substantive data fields, and wherein said plurality of forms are stored in said generic forms database before they are personalized or programmed;
personalizing said plurality of forms to conform to the needs of an employer;
programming said plurality of forms, by a form type, to be distributed automatically to an one or more employer representatives via said virtual notification system after said plurality of forms are locked;
programming said plurality of forms with a tutorial system that provides a real time legal guidance to said one or more employer representatives as to how to appropriately complete said one or more substantive data fields of said plurality of forms;
programming said plurality of forms with a legal notification system that flags in real time an one or more inappropriate words in a comment that said one or more employer representatives enters into said plurality of forms, and suggests an one or more alternative words for said comment;
storing said plurality of forms in said programmed forms database after said plurality of forms are personalized and programmed;
accessing a specific form from said programmed forms database;
pre-populating electronically an one or more demographic fields of said specific form with said plurality of employee demographic data available from said employee demographic database;
completing electronically said one or more substantive data fields in said specific form, wherein said tutorial system provides said real time legal guidance to said one or more employer representatives, and wherein said legal notification system flags in real time said one or more inappropriate words in said comment that said one or more employer representatives enters into said plurality of forms, and wherein said legal notification system suggests said one or more alternative words for said comment;
sharing electronically said specific form with additional said one or more employer representatives before said specific form is shared with an employee to whom said specific form relates;
allowing additional said one or more employer representatives to edit said specific form before said specific form is shared with said employee to whom said specific form relates;
printing said specific form, wherein said specific form is divided into a printed specific form and an electronic specific form;
placing said printed specific form on an electronic mark capture clipboard, wherein said electronic mark capture clipboard is programmed to capture in real time an one or more marks made to said printed specific form with an ink-magnet pen and simultaneously capture said one or more marks into said electronic specific form;
sharing said printed specific form with said employee;
allowing said employee to mark said printed specific form with said ink-magnet pen;
allowing said one or more employer representatives to mark said printed specific form with said ink-magnet pen;
locking said electronic specific form after said printed specific form is finished being marked, wherein said electronic specific form is automatically date stamped at locking;
distributing said printed specific form to said employee;
distributing automatically said electronic specific form to said one or more employer representatives via said virtual notification system;
storing said electronic specific form in said electronic file drawer;
storing a plurality of substantive data from said substantive data fields in said reports database;
allowing said one or more employer representatives to access said electronic file drawer to retrieve an one or more locked and stored electronic forms;
allowing said one or more third parties to access said human resources employment system and said electronic file drawer to retrieve said one or more locked and stored electronic forms;
allowing said one or more third parties to access said human resources employment system and said electronic file drawer to retrieve said employee demographic data;
allowing said one or more third parties to place an one or more third party forms in said electronic file drawer; and
allowing said one or more employer representatives to attach an one or more supplementary documents to said electronic specific form, wherein said one or more supplementary documents are stored with said electronic specific form in said electronic file drawer after said electronic specific form is locked;
wherein said specific form is a request form;
sending electronically said request form to said one or more third parties;
receiving electronically a result form from said one or more third parties in response to said request form; and
storing said result form in said electronic file drawer;
wherein said unemployment database is used to respond to and manage an unemployment claim.
